(19) United States
(12) Patent Application Publication
(10) Pub. No.: US 2019/0007892 A1
(43) Pub. Date: Jan. 3, 2019

(54) UPDATING SYSTEM INFORMATION FOR 5G CELLULAR SYSTEMS

(71) Applicant: QUALCOMM Incorporated, San Diego, CA (US)

(72) Inventors: Ansah Ahmed Sheik, Hyderabad (IN); Sahas Sathyanarayana, Hyderabad (IN); Vishnu Namboodiri Karakkad Kesavan Namboodiri, Hyderabad (IN); Rajesh Gopala Krishnan, Hyderabad (IN); Mukesh Kumar, Hyderabad (IN)

(21) Appl. No.: 16/019,383

(22) Filed: Jun. 26, 2018

(30) Foreign Application Priority Data
Jun. 28, 2017 (IN) 201741022519

(51) Int. Cl. H04W 48/10; H04W 72/04; H04L 5/00; H04W 68/00; H04W 36/00

(52) U.S. Cl. CPC H04W 48/10; H04W 72/0406; H04W 36/0077; H04W 68/00; H04L 5/0053

(57) ABSTRACT

Methods, systems, and devices for wireless communication are described. System information may be updated during wireless communications. A base station may transmit an indication of such a change to a wireless device. In some cases, the indication may include a priority of the system information change. The base station may set a time duration for the system information change, and broadcast one or more information blocks (e.g., indicating the updated system information) during the time duration. Upon expiration of a timer associated with the time duration, the base station may return to transmitting the one or more information blocks to the wireless device in response to requests from the wireless device. In some cases, the system information change may be broadcast in response to receiving multiple requests to transmit the first type of information block from a plurality of wireless devices served by the base station.

### CROSS REFERENCES

The present Application for Patent claims the benefit of India Provisional Patent Application No. 201741022519 by SHEIK, et al., entitled “Updating System Information For 5G Cellular Systems,” filed Jun. 28, 2017, assigned to the assignee hereof, and expressly incorporated herein.

### BACKGROUND

The following relates generally to wireless communication, and more specifically to improved system information updating for cellular systems.

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include code division multiple access (CDMA) systems, time division multiple access (TDMA) systems, frequency division multiple access (FDMA) systems, and orthogonal frequency division multiple access (OFDMA) systems, (e.g., a Long Term Evolution (LTE) system, or a New Radio (NR) system). A wireless multiple-access communications system may include a number of base stations or access network nodes, each simultaneously supporting communication for multiple communication devices, which may be otherwise known as user equipment (UE).

A base station and a UE may exchange system information (SI) (e.g., system frame number (SFN) information, public land mobile network (PLMN) information, Cell ID, etc.) for cell acquisition, cell reselection, cell camping, etc. SI conveyed via a minimum system information block (MSIB) and an other system information block (OSIB) may be broadcast by the network to UEs within the cell. In some cases, unicast transmissions may be sent to convey SI to UEs. SI that is broadcast to UEs may be associated with large over the air (OTA) overhead and may, in some cases, consume such OTA resources unnecessarily (e.g., due to broadcasting redundant information). Further, SI conveyed via unicast transmissions may also be associated with inefficient OTA usage when conveying multiple copies of the same SI to multiple UEs. Improved techniques for SI exchange and distribution may thus be desired.

### SUMMARY

The described techniques relate to improved methods, systems, devices, or apparatuses that support improved system information updating for cellular systems. Generally, the described techniques provide for multiple transmission mechanisms to convey system information efficiently. A base station may transmit an indication of a system information change to a wireless device. In some cases, the indication may include a priority (e.g., a criticality) of the system information change. The base station may set a time duration for the system information change, and broadcast one or more of a first type of information block (e.g., indicating the updated system information) during the time duration. Upon expiration of a timer associated with the time duration, the base station may return to transmitting the first type of information blocks to the wireless device in response to requests from the wireless device. In some cases, the system information change may be broadcast in response to receiving multiple requests to transmit the first type of information block from a plurality of wireless devices served by the base station. The first type of information block may be an other system information block (OSIB) (which may also be referred to as and be the equivalent of an on-demand SIB (OSIB)), while a second type of information block broadcast by the base station may be a minimum system information block (MSIB) (which may also be referred to as and be the equivalent of a mandatory SIB (MSIB)).

Specifically, a base station may transmit, to a user equipment (UE), an indication of a system information change and set, based at least in part on transmitting the indication, a time duration for the system information change. The base station may then broadcast, during the time duration and based at least in part on the system information change, one or more of a first type of information block. Upon expiration of the time duration, the base station may return to transmitting the first type of information block to the UE in response to one or more requests from the UE.

Moreover, a UE may receive, from a base station, an indication of a system information change and set, based at least in part on the received indication, a time duration for the system information change. The UE may then receive, during the time duration and based at least in part on the indication of the system information change, one or more of a first type of information block broadcast by the base station. Upon expiration of the time duration, the UE may return to monitoring for the first type of information block transmitted to the UE from the base station.

A method of wireless communication is described. The method may include transmitting, to a UE, an indication of a system information change and setting, based at least in part on transmitting the indication, a time duration for the system information change. The method may further include broadcasting, during the time duration and based at least in part on the system information change, one or more of a first type of information block, and returning, based at least in part on an expiration of the time duration, to transmitting the first type of information block to the UE in response to one or more requests from the UE.

An apparatus for wireless communication is described. The apparatus may include means for transmitting, to a UE, an indication of a system information change, and means for setting, based at least in part on transmitting the indication, a time duration for the system information change. The apparatus may further include means for broadcasting, during the time duration and based at least in part on the system information change, one or more of a first type of information block, and means for returning, based at least in part on an expiration of the time duration, to transmitting the first type of information block to the UE in response to one or more requests from the UE.

Another apparatus for wireless communication is described. The apparatus may include a processor, memory in electronic communication with the processor, and instructions stored in the memory. The instructions may be operable to cause the processor to transmit, to a UE, an indication of a system information change, and set, based at least in part on transmitting the indication, a time duration for the system information change. The instructions may be further operable to cause the processor to broadcast, during the time duration and based at least in part on the system information change, one or more of a first type of information block, and return, based at least in part on an expiration of the time duration, to transmitting the first type of information block to the UE in response to one or more requests from the UE.

A non-transitory computer readable medium for wireless communication is described. The non-transitory computer-readable medium may include instructions operable to cause a processor to transmit, to a UE, an indication of a system information change, and set, based at least in part on transmitting the indication, a time duration for the system information change. The non-transitory computer-readable medium may include instructions further operable to cause a processor to broadcast, during the time duration and based at least in part on the system information change, one or more of a first type of information block, and return, based at least in part on an expiration of the time duration, to transmitting the first type of information block to the UE in response to one or more requests from the UE.

Some examples of the method, apparatus, and non-transitory computer-readable medium described above may further include processes, features, means, or instructions for transmitting, to the UE, an indication of a priority of the system information change. In some examples of the method, apparatus, and non-transitory computer-readable medium described above, transmitting the indication of the system information change comprises: transmitting a paging message, the paging message including a cause field indicating the system information change, or an information block type, or a combination thereof.

Some examples of the method, apparatus, and non-transitory computer-readable medium described above may further include processes, features, means, or instructions for receiving a plurality of requests to transmit the first type of information block from a plurality of UEs served by the base station. Some examples of the method, apparatus, and non-transitory computer-readable medium described above may further include processes, features, means, or instructions for identifying that a number of the plurality of requests satisfy a threshold, wherein the indication of the system information change may be transmitted based at least in part on the identification.

In some examples of the method, apparatus, and non-transitory computer-readable medium described above, broadcasting the one or more of the first type of information block comprises: broadcasting a first of the first type of information block together with at least one other of the first type of information block.

In some examples of the method, apparatus, and non-transitory computer-readable medium described above, broadcasting the one or more of the first type of information block comprises: broadcasting a first of the first type of information block together with a second type of information block. In some examples of the method, apparatus, and non-transitory computer-readable medium described above the first type of information block is associated with a first repetition rate and the second type of information block is associated with a second repetition rate.

In some examples of the method, apparatus, and non-transitory computer-readable medium described above, the first type of information block may be an other system information block (OSIB). In some examples of the method, apparatus, and non-transitory computer-readable medium described above, the second type of information block may be a minimum system information block (MSIB).

In some examples of the method, apparatus, and non-transitory computer-readable medium described above, broadcasting the one or more of the first type of information block includes broadcasting a plurality of instances of the one or more of the first type of information block during the time duration. Some examples of the method, apparatus, and non-transitory computer-readable medium described above may further include processes, features, means, or instructions for broadcasting a second type of information block, wherein the second type of information block comprises information for at least one of the one or more of the first type of information block.

In some examples of the method, apparatus, and non-transitory computer-readable medium described above, the information for at least one of the one or more of the first type of information block comprises an indicator to identify the one or more of the first type of information block as periodic or as provided on request, a type, or a validity, or a periodicity, or a window, or a combination thereof.

Some examples of the method, apparatus, and non-transitory computer-readable medium described above may further include processes, features, means, or instructions for identifying the system information change, wherein the base station includes a first cell, and the system information change may be a change in information for a second cell. Some examples of the method, apparatus, and non-transitory computer-readable medium described above may further include processes, features, means, or instructions for identifying a status of the second cell, a frequency of the second cell, a quality of service setting for the second cell, or an access barring information, or a combination thereof.

A method of wireless communication is described. The method may include receiving, from a base station, an indication of a system information change, and setting, based at least in part on the received indication, a time duration for the system information change. The method may further include receiving, during the time duration and based at least in part on the indication of the system information change, one or more of a first type of information block broadcast by the base station, and returning, based at least in part on an expiration of the time duration, to monitoring for the first type of information block transmitted to the UE from the base station.

An apparatus for wireless communication is described. The apparatus may include means for receiving, from a base station, an indication of a system information change, and means for setting, based at least in part on the received indication, a time duration for the system information change. The apparatus may further include means for receiving, during the time duration and based at least in part on the indication of the system information change, one or more of a first type of information block broadcast by the base station, and means for returning, based at least in part on an expiration of the time duration, to monitoring for the first type of information block transmitted to the UE from the base station.

Another apparatus for wireless communication is described. The apparatus may include a processor, memory in electronic communication with the processor, and instructions stored in the memory. The instructions may be operable to cause the processor to receive, from a base station, an indication of a system information change, and set, based at least in part on the received indication, a time duration for the system information change. The instructions may be operable to further cause the processor to receive, during the time duration and based at least in part on the indication of the system information change, one or more of a first type of information block broadcast by the base station, and return, based at least in part on an expiration of the time duration, to monitoring for the first type of information block transmitted to the UE from the base station.

A non-transitory computer readable medium for wireless communication is described. The non-transitory computer-readable medium may include instructions operable to cause a processor to receive, from a base station, an indication of a system information change, and set, based at least in part on the received indication, a time duration for the system information change. The non-transitory computer-readable medium may include instructions operable to further cause the processor to receive, during the time duration and based at least in part on the indication of the system information change, one or more of a first type of information block broadcast by the base station, and return, based at least in part on an expiration of the time duration, to monitoring for the first type of information block transmitted to the UE from the base station.

In some examples of the method, apparatus, and non-transitory computer-readable medium described above, the one or more of the first type of information block broadcast by the base station may be received based at least in part on the request. In some examples of the method, apparatus, and non-transitory computer-readable medium described above, receiving the one or more of the first type of information block comprises: receiving, from the base station, a first of the first type of information block together with at least one other of the first type of information block.

In some examples of the method, apparatus, and non-transitory computer-readable medium described above, receiving the one or more of the first type of information block comprises: receiving, from the base station, a first of the first type of information block together with a second type of information block. In some examples of the method, apparatus, and non-transitory computer-readable medium described above, the first type of information block is associated with a first repetition rate and the second type of information block is associated with a second repetition rate

Some examples of the method, apparatus, and non-transitory computer-readable medium described above may further include processes, features, means, or instructions for receiving a second type of information block, wherein the second type of information block comprises information for at least one of the one or more of the first type of information block.

In some examples of the method, apparatus, and non-transitory computer-readable medium described above, the information for at least one of the one or more of the first type of information block comprises an indicator to identify the one or more of the first type of information block as periodic or as provided on request, a type, or a validity, or a periodicity, or a window, or a combination thereof.

In some examples of the method, apparatus, and non-transitory computer-readable medium described above, the first type of information block may be an OSIB. In some examples of the method, apparatus, and non-transitory computer-readable medium described above, the second type of information block may be a MSIB.

### BRIEF DESCRIPTION OF THE DRAWINGS

FIG. 1 illustrates an example of a system for wireless communication that supports improved system information updating for cellular systems in accordance with aspects of the present disclosure.

FIG. 2 illustrates an example of a wireless communications system that supports improved system information updating for cellular systems in accordance with aspects of the present disclosure.

FIG. 3 illustrates an example of a flow chart that supports improved system information updating for cellular systems in accordance with aspects of the present disclosure.

FIG. 4 illustrates an example of a process flow that supports improved system information updating for cellular systems in accordance with aspects of the present disclosure.

FIG. 5 illustrates an example of a process flow that supports improved system information updating for cellular systems in accordance with aspects of the present disclosure.

FIGS. 6 through 8 show block diagrams of a device that supports improved system information updating for cellular systems in accordance with aspects of the present disclosure.

FIG. 9 illustrates a block diagram of a system including a base station that supports improved system information updating for cellular systems in accordance with aspects of the present disclosure.

FIGS. 10 through 12 show block diagrams of a device that supports improved system information updating for cellular systems in accordance with aspects of the present disclosure.

FIG. 13 illustrates a block diagram of a system including a user equipment (UE) that supports improved system information updating for cellular systems in accordance with aspects of the present disclosure.

FIGS. 14 through 17 illustrate methods for improved system information updating for cellular systems in accordance with aspects of the present disclosure.

### DETAILED DESCRIPTION

A base station and a UE may exchange system information (SI) (e.g., system frame number (SFN) information, public land mobile network (PLMN) information, Cell identification (ID), etc.) for cell acquisition, cell reselection, cell camping, etc. In some cases, SI may be divided into at least two categories: minimum SI (e.g., conveyed via minimum system information blocks (MSIBs), which may also be referred to as and be the equivalent of a mandatory SIB (MSIB)), and other SI (e.g., conveyed via other system information blocks (OSIBs) which may also be referred to as and be the equivalent of an on-demand SIB (OSIB)). MSIBs may include the minimum or basic SI necessary for initial access by a user equipment (UE) to a cell, in addition to SI necessary to acquire additional system information (e.g., OSIBs). For example, MSIBs may include information such as cell operating bandwidth, physical hybrid indicator channel (PHICH) configuration, SFN information, etc. for a UE to use for initial cell access, as well as OSIB scheduling information. OSIBs may be received (e.g., based on information obtained via MSIB), and may include information such as availability of neighbor cells, operating frequencies of neighbor cells, PLMN IDs, etc.

In some cases, a network may desire to update SI due to, for example, a change in availability of neighbor cells, a change in operating frequency of neighbor cells, change in quality of service (QoS) of neighbor cells, etc. The neighbor cell may represent any cell from which a UE may receive transmissions containing SI. Some wireless communications systems may have fixed MSIB and OSIB scheduling, such that all SIBs are broadcast to UEs within a cell. However, this may result in increased, and for example unnecessary, over the air (OTA) signaling. An SI that is broadcast to UEs may be associated with large OTA overhead and may, in some cases, consume resources unnecessarily (e.g., due to broadcasting redundant information, etc.). That is, some SI (e.g., some or all SIBs) may be broadcast continuously (e.g., periodically at a certain interval), such that large OTA resources are consumed regardless of whether UEs are reading or awaiting the SIBs. The continuous broadcasts may have a fixed, periodic schedule. Further, delay in obtaining certain information may occur for some interested UEs due to such fixed scheduling. Further, SI conveyed via unicast transmissions (e.g., on-demand OSIBs) may also be associated with inefficient OTA usage when conveying SI to multiple UEs. For example, UEs determine a change in Other SI, all or many UEs within the network may request on-demand (e.g., unicast) SIBs. The resulting multiple unicast SIBs to many UEs may result in large overhead.

Therefore, techniques for selecting an SI transmission scheme (e.g., a broadcast or unicast transmission mechanism) given certain network conditions may improve system performance, for example by reducing OTA signaling, decreasing latency associated with updating SI, etc. According to transmission mechanisms described herein, SI (e.g., other SI) may be broadcast for a certain time interval T. Outside of the interval T, for example after the expiration of a timer having a time duration T, wireless communications system 200 may revert to on-demand transmission of such SI. In some cases, the broadcast SI transmissions (e.g., during the interval T) may include an OSIB, more than one OSIB transmitted together, or may include one or more OSIBs padded together with an MSIB. An indication (e.g., a “SI change in Other SI” indication) may be sent to UEs indicating that SI has changed for an OSIB. The SI for whom the indication has been sent may be broadcast for the T duration.

Broadcasting SI in such a manner may improve network efficiency. For example, by broadcasting SI for a duration T, and then reverting back to unicast mode outside the interval T, OTA resources used and the delay UEs may experience before acquiring updated SIBs may be reduced. As such, UEs not interested in certain OSIBs are not impacted because they do not receive unneeded or redundant information in those OSIBs. Interested UEs may receive updated SI via on-demand OSIB transmission or, when updated OSIB information applies to many UEs, interested UEs may receive updated SI via a broadcast during a T interval, reducing OTA resources. For example, UEs may request a certain OSIB (e.g., a SIB-x), which may be transmitted during the next T interval broadcast. Therefore, redundant information (e.g., OSIBs not including SIB-x) may not be rebroadcast according to some periodicity, thus reducing OTA resources associated with such rebroadcasting. This may result in reduced OTA signaling and increased SI signaling efficiency. UEs may be updated according to changed SIB values more effectively, and as needed. Power limited (e.g., battery critical) UEs may especially benefit from OTA reduction and reduced wakeup times.

Aspects of the disclosure are initially described in the context of a wireless communications system. Example flow charts and process flows enabling techniques discussed herein are then described. Aspects of the disclosure are further illustrated by and described with reference to apparatus diagrams, system diagrams, and flowcharts that relate to improved system information updating for cellular systems.

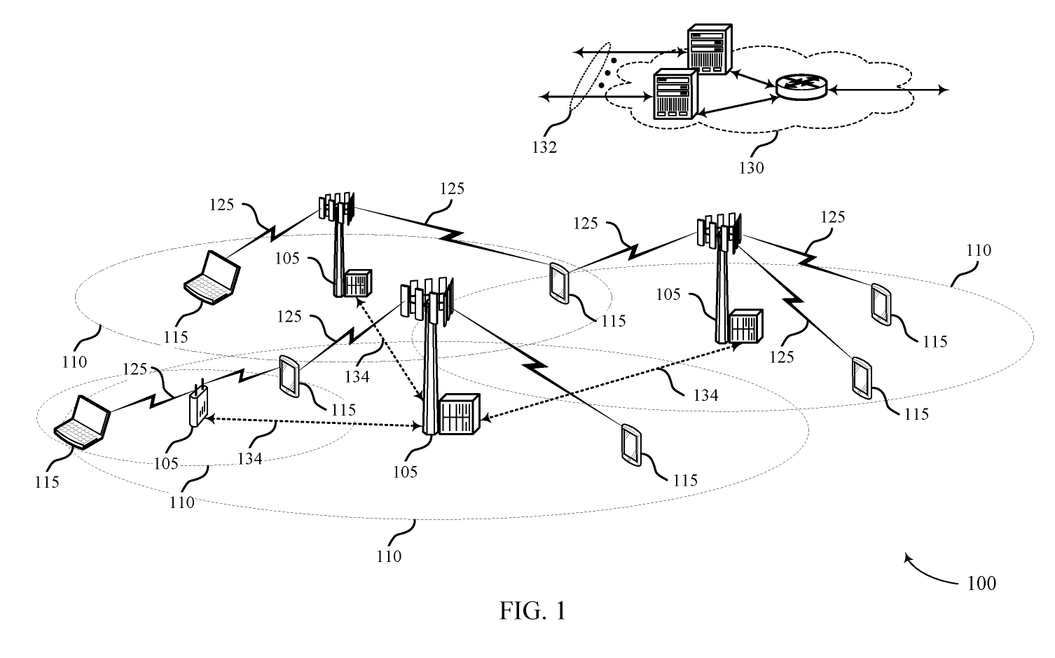

FIG. 1 illustrates an example of a wireless communications system 100 in accordance with various aspects of the present disclosure. The wireless communications system 100 includes base stations 105, UEs 115, and a core network 130. In some examples, the wireless communications system 100 may be a Long Term Evolution (LTE), LTE-Advanced (LTE-A) network, or a New Radio (NR) network. In some cases, wireless communications system 100 may support enhanced broadband communications, ultra-reliable (i.e., mission critical) communications, low latency communications, and communications with low-cost and low-complexity devices.

Base stations 105 may wirelessly communicate with UEs 115 via one or more base station antennas. Each base station 105 may provide communication coverage for a respective geographic coverage area 110. Communication links 125 shown in wireless communications system 100 may include uplink transmissions from a UE 115 to a base station 105, or downlink transmissions, from a base station 105 to a UE 115. Control information and data may be multiplexed on an uplink channel or downlink according to various techniques. Control information and data may be multiplexed on a downlink channel, for example, using time division multiplexing (TDM) techniques, frequency division multiplexing (FDM) techniques, or hybrid TDM-FDM techniques. In some examples, the control information transmitted during a transmission time interval (TTI) of a downlink channel may be distributed between different control regions in a cascaded manner (e.g., between a common control region and one or more UE-specific control regions).

UEs 115 may be dispersed throughout the wireless communications system 100, and each UE 115 may be stationary or mobile. A UE 115 may also be referred to as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. A UE 115 may also be a cellular phone, a personal digital assistant (PDA), a wireless modem, a wireless communication device, a handheld device, a tablet computer, a laptop computer, a cordless phone, a personal electronic device, a handheld device, a personal computer, a wireless local loop (WLL) station, an Internet of Things (IoT) device, an Internet of Everything (IoE) device, a machine type communication (MTC) device, an appliance, an automobile, or the like.

In some cases, a UE 115 may also be able to communicate directly with other UEs (e.g., using a peer-to-peer (P2P) or device-to-device (D2D) protocol). One or more of a group of UEs 115 utilizing D2D communications may be within the coverage area 110 of a cell. Other UEs 115 in such a group may be outside the coverage area 110 of a cell, or otherwise unable to receive transmissions from a base station 105. In some cases, groups of UEs 115 communicating via D2D communications may utilize a one-to-many (1:M) system in which each UE 115 transmits to every other UE 115 in the group. In some cases, a base station 105 facilitates the scheduling of resources for D2D communications. In other cases, D2D communications are carried out independent of a base station 105.

Some UEs 115, such as MTC or IoT devices, may be low cost or low complexity devices, and may provide for automated communication between machines, i.e., Machine-to-Machine (M2M) communication. M2M or MTC may refer to data communication technologies that allow devices to communicate with one another or a base station without human intervention. For example, M2M or MTC may refer to communications from devices that integrate sensors or meters to measure or capture information and relay that information to a central server or application program that can make use of the information or present the information to humans interacting with the program or application. Some UEs 115 may be designed to collect information or enable automated behavior of machines. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

In some cases, an MTC device may operate using half-duplex (one-way) communications at a reduced peak rate. MTC devices may also be configured to enter a power saving “deep sleep” mode when not engaging in active communications. In some cases, MTC or IoT devices may be designed to support mission critical functions and wireless communications system may be configured to provide ultra-reliable communications for these functions.

Base stations 105 may communicate with the core network 130 and with one another. For example, base stations 105 may interface with the core network 130 through backhaul links 132 (e.g., S1, etc.). Base stations 105 may communicate with one another over backhaul links 134 (e.g., X2, etc.) either directly or indirectly (e.g., through core network 130). Base stations 105 may perform radio configuration and scheduling for communication with UEs 115, or may operate under the control of a base station controller (not shown). In some examples, base stations 105 may be macro cells, small cells, hot spots, or the like. Base stations 105 may also be referred to as evolved NodeBs (eNBs) 105.

A base station 105 may be connected by an S1 interface to the core network 130. The core network may be an evolved packet core (EPC), which may include at least one mobility management entity (MME), at least one serving gateway (S-GW), and at least one Packet Data Network (PDN) gateway (P-GW). The MME may be the control node that processes the signaling between the UE 115 and the EPC. All user Internet Protocol (IP) packets may be transferred through the S-GW, which itself may be connected to the P-GW. The P-GW may provide IP address allocation as well as other functions. The P-GW may be connected to the network operators IP services. The operators IP services may include the Internet, the Intranet, an IP Multimedia Subsystem (IMS), and a Packet-Switched (PS) Streaming Service.

The core network 130 may provide user authentication, access authorization, tracking, Internet Protocol (IP) connectivity, and other access, routing, or mobility functions. At least some of the network devices, such as base station 105-a may include subcomponents such as an access network entity 105-b, which may be an example of an access node controller (ANC). Each access network entity 105-b may communicate with a number of UEs 115 through a number of other access network transmission entities 105-c, each of which may be an example of a smart radio head, or a transmission/reception point (TRP). In some configurations, various functions of each access network entity or base station 105 may be distributed across various network devices (e.g., radio heads and access network controllers) or consolidated into a single network device (e.g., a base station 105).

Wireless communications system 100 may operate in an ultra-high frequency (UHF) frequency region using frequency bands from 700 MHz to 2600 MHz (2.6 GHz), although some networks (e.g., a wireless local area network (WLAN)) may use frequencies as high as 4 GHz. This region may also be known as the decimeter band, since the wavelengths range from approximately one decimeter to one meter in length. UHF waves may propagate mainly by line of sight, and may be blocked by buildings and environmental features. However, the waves may penetrate walls sufficiently to provide service to UEs 115 located indoors. Transmission of UHF waves is characterized by smaller antennas and shorter range (e.g., less than 100 km) compared to transmission using the smaller frequencies (and longer waves) of the high frequency (HF) or very high frequency (VHF) portion of the spectrum. In some cases, wireless communications system 100 may also utilize extremely high frequency (EHF) portions of the spectrum (e.g., from 30 GHz to 300 GHz). This region may also be known as the millimeter band, since the wavelengths range from approximately one millimeter to one centimeter in length. Thus, EHF antennas may be even smaller and more closely spaced than UHF antennas. In some cases, this may facilitate use of antenna arrays within a UE 115 (e.g., for directional beamforming). However, EHF transmissions may be subject to even greater atmospheric attenuation and shorter range than UHF transmissions.

Thus, wireless communications system 100 may support millimeter wave (mmW) communications between UEs 115 and base stations 105. Devices operating in mmW or EHF bands may have multiple antennas to allow beamforming. That is, a base station 105 may use multiple antennas or antenna arrays to conduct beamforming operations for directional communications with a UE 115. Beamforming (which may also be referred to as spatial filtering or directional transmission) is a signal processing technique that may be used at a transmitter (e.g., a base station 105) to shape and/or steer an overall antenna beam in the direction of a target receiver (e.g., a UE 115). This may be achieved by combining elements in an antenna array in such a way that transmitted signals at particular angles experience constructive interference while others experience destructive interference.

Multiple-input multiple-output (MIMO) wireless systems use a transmission scheme between a transmitter (e.g., a base station 105) and a receiver (e.g., a UE 115), where both transmitter and receiver are equipped with multiple antennas. Some portions of wireless communications system 100 may use beamforming. For example, base station 105 may have an antenna array with a number of rows and columns of antenna ports that the base station 105 may use for beamforming in its communication with UE 115. Signals may be transmitted multiple times in different directions (e.g., each transmission may be beamformed differently). A mmW receiver (e.g., a UE 115) may try multiple beams (e.g., antenna subarrays) while receiving the synchronization signals.

In some cases, the antennas of a base station 105 or UE 115 may be located within one or more antenna arrays, which may support beamforming or MIMO operation. One or more base station antennas or antenna arrays may be collocated at an antenna assembly, such as an antenna tower. In some cases, antennas or antenna arrays associated with a base station 105 may be located in diverse geographic locations. A base station 105 may multiple use antennas or antenna arrays to conduct beamforming operations for directional communications with a UE 115.

In some cases, wireless communications system 100 may be a packet-based network that operate according to a layered protocol stack. In the user plane, communications at the bearer or Packet Data Convergence Protocol (PDCP) layer may be IP-based. A Radio Link Control (RLC) layer may in some cases perform packet segmentation and reassembly to communicate over logical channels. A Medium Access Control (MAC) layer may perform priority handling and multiplexing of logical channels into transport channels. The MAC layer may also use Hybrid ARQ (HARD) to provide retransmission at the MAC layer to improve link efficiency. In the control plane, the Radio Resource Control (RRC) protocol layer may provide establishment, configuration, and maintenance of an RRC connection between a UE 115 and a network device 105-c, network device 105-b, or core network 130 supporting radio bearers for user plane data. At the Physical (PHY) layer, transport channels may be mapped to physical channels.

Time intervals in LTE or NR may be expressed in multiples of a basic time unit (which may be a sampling period of Tₛ=1/30,720,000 seconds). Time resources may be organized according to radio frames of length of 10 ms (T_{f}=307200Tₛ), which may be identified by a system frame number (SFN) ranging from 0 to 1023. Each frame may include ten 1 ms subframes numbered from 0 to 9. A subframe may be further divided into two 0.5 ms slots, each of which contains 6 or 7 modulation symbol periods (depending on the length of the cyclic prefix prepended to each symbol). Excluding the cyclic prefix, each symbol contains 2048 sample periods. In some cases the subframe may be the smallest scheduling unit, also known as a TTI. In other cases, a TTI may be shorter than a subframe or may be dynamically selected (e.g., in short TTI bursts or in selected component carriers using short TTIs).

A resource element may consist of one symbol period and one subcarrier (e.g., a 15 KHz frequency range). A resource block may contain 12 consecutive subcarriers in the frequency domain and, for a normal cyclic prefix in each OFDM symbol, 7 consecutive OFDM symbols in the time domain (1 slot), or 84 resource elements. The number of bits carried by each resource element may depend on the modulation scheme (the configuration of symbols that may be selected during each symbol period). Thus, the more resource blocks that a UE receives and the higher the modulation scheme, the higher the data rate may be.

Wireless communications system 100 may support operation on multiple cells or carriers, a feature which may be referred to as carrier aggregation (CA) or multi-carrier operation. A carrier may also be referred to as a component carrier (CC), a layer, a channel, etc. The terms “carrier,” “component carrier,” “cell,” and “channel” may be used interchangeably herein. A UE 115 may be configured with multiple downlink CCs and one or more uplink CCs for carrier aggregation. Carrier aggregation may be used with both FDD and TDD component carriers.

In some cases, wireless communications system 100 may utilize enhanced component carriers (eCCs). An eCC may be characterized by one or more features including: wider bandwidth, shorter symbol duration, shorter TTIs, and modified control channel configuration. In some cases, an eCC may be associated with a carrier aggregation configuration or a dual connectivity configuration (e.g., when multiple serving cells have a suboptimal or non-ideal backhaul link). An eCC may also be configured for use in unlicensed spectrum or shared spectrum (where more than one operator is allowed to use the spectrum). An eCC characterized by wide bandwidth may include one or more segments that may be utilized by UEs 115 that are not capable of monitoring the whole bandwidth or prefer to use a limited bandwidth (e.g., to conserve power).

In some cases, an eCC may utilize a different symbol duration than other CCs, which may include use of a reduced symbol duration as compared with symbol durations of the other CCs. A shorter symbol duration is associated with increased subcarrier spacing. A device, such as a UE 115 or base station 105, utilizing eCCs may transmit wideband signals (e.g., 20, 40, 60, 80 MHz, etc.) at reduced symbol durations (e.g., 16.67 microseconds). A TTI in eCC may consist of one or multiple symbols. In some cases, the TTI duration (that is, the number of symbols in a TTI) may be variable.

A shared radio frequency spectrum band may be utilized in an NR shared spectrum system. For example, an NR shared spectrum may utilize any combination of licensed, shared, and unlicensed spectrums, among others. The flexibility of eCC symbol duration and subcarrier spacing may allow for the use of eCC across multiple spectrums. In some examples, NR shared spectrum may increase spectrum utilization and spectral efficiency, specifically through dynamic vertical (e.g., across frequency) and horizontal (e.g., across time) sharing of resources.

In some cases, wireless communications system 100 may utilize both licensed and unlicensed radio frequency spectrum bands. For example, wireless communications system 100 may employ LTE License Assisted Access (LTE-LAA) or LTE Unlicensed (LTE U) radio access technology or NR technology in an unlicensed band such as the 5 Ghz Industrial, Scientific, and Medical (ISM) band. When operating in unlicensed radio frequency spectrum bands, wireless devices such as base stations 105 and UEs 115 may employ listen-before-talk (LBT) procedures to ensure the channel is clear before transmitting data. In some cases, operations in unlicensed bands may be based on a CA configuration in conjunction with CCs operating in a licensed band. Operations in unlicensed spectrum may include downlink transmissions, uplink transmissions, or both. Duplexing in unlicensed spectrum may be based on frequency division duplexing (FDD), time division duplexing (TDD) or a combination of both.

In some cases, after completing initial cell synchronization, a UE 115 may decode the MSIB, and some OSIBs (e.g., SIB1 and SIB2), prior to accessing the network. The MSIB may be transmitted on, for example, physical broadcast channel (PBCH) and may utilize the first 4 OFDMA symbols of the second slot of the first subframe of each radio frame. It may use the middle 6 RBs (72 subcarriers) in the frequency domain. The MSIB may carry information for UE initial access, including such as downlink channel bandwidth (e.g., in terms of resource blocks, physical hybrid indicator channel (PHICH) configuration (duration and resource assignment), system frame number (SFN) information, etc. A MSIB may be broadcast periodically (e.g., every fourth radio frame (SFN mod 4=0) and rebroadcast every frame (10 ms)). Each repetition may be scrambled with a different scrambling code. After reading a MSIB (either a new version or a copy), the UE 115 may try different phases of a scrambling code until it gets a successful cyclic redundancy check (CRC). The phase of the scrambling code (0, 1, 2 or 3) may enable the UE 115 to identify which of the four repetitions has been received. Thus, the UE 115 may determine the current SFN by reading the SFN in the decoded transmission and adding the scrambling code phase. After receiving the MSIB, a UE 115 may receive one or more SIBs. Different SIBs may be defined according to the type of system information conveyed. SIBs may include access information such as cell identity information, whether a UE is allowed to camp on a cell, cell selection information (or cell selection parameters), scheduling information for other SIBs, access information and parameters related to common and shared channels, etc. Different SIBs may be defined according to the type of system information conveyed. For example a SIB1 may include access information such as cell identity information, and may also indicate whether a UE 115 is allowed to camp on a cell. SIB1 may also include cell selection information (or cell selection parameters). As further described herein, a UE 115 may receive an indication of a change in system information, such that a timer with time duration T may be set, and one or more SIBs broadcast including the changed, or updated, system information. After the time duration (after the timer expires), the different SIBs may be delivered to UEs upon request from the UE in a unicast transmission. The change in system information may be a change in information for a neighbor cell (e.g., a second cell different from a serving cell of the UEs), a status change of the neighbor cell, a change in frequency of the neighbor cell, a change in QoS of the neighbor cell, etc. In other examples, additional or different changes (or combinations of changes) in system information may also be received by UE 115, such that the time duration may be set based on these changes instead or as well. Broadcasting the one or more SIBs may include broadcasting multiple instances of a SIB during the duration, for example broadcasting the same SIB at a regular interval for the time duration T.

Each cell on which a UE 115 is allowed to camp may broadcast at least some contents of the minimum SI, while there may be cells in the wireless communications system 100 on which the UE 115 may camp and do not broadcast the minimum SI. For a cell/frequency that is considered for camping by the UE 115, the UE 115 may not acquire the contents of the minimum SI of that cell/frequency from another cell/frequency layer. If the UE 115 cannot determine the full contents of the minimum SI of a cell (by receiving from that cell or from valid stored SI from previous cells), the UE may consider that cell as barred. It may be desirable for the UE 115 to learn very quickly that this cell cannot be camped on. It may further be desirable for the UE 115 to efficiently learn other information stored in SI quickly. As such wireless communications system 100 may support techniques for system information updating for cellular systems as described herein. Specifically, wireless communications system 100 may support interval broadcast and on-demand SI transmission mechanisms, used according to the description below.

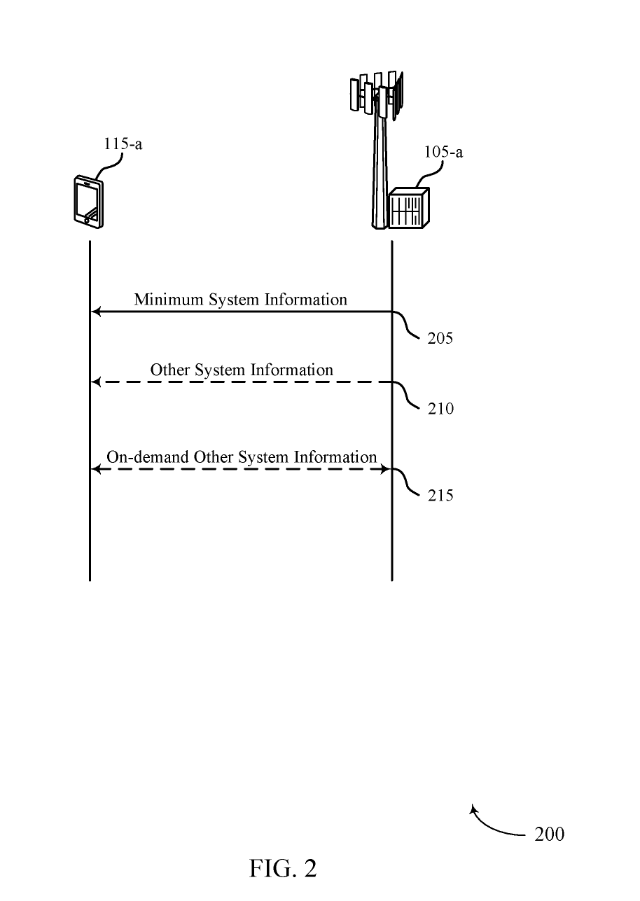

FIG. 2 illustrates an example of a wireless communications system 200 that supports improved system information updating for cellular systems in accordance with various aspects of the present disclosure. In some examples, wireless communications system 200 may implement aspects of wireless communications system 100. For example, wireless communications system may illustrate communications between UE 115-a and base station 105-a, which may represent aspects of corresponding devices as discussed with reference to FIG. 1. To reduce OTA signaling, wireless communications system 200 may divide or categorize system information (SI) into minimum SI (e.g., conveyed via MSIBs) and other SI (e.g., conveyed via OSIBs). Minimum SI 205 (e.g., MSIBs) may be broadcast periodically. As an example, UE 115-a may receive minimum SI 205 periodically from base station 105-a. Before UE 115-a sends an other SI request, the UE 115-a may determine the status of other SI 210 (e.g., determine whether other SI 210 is already present, is broadcasted, unicasted, etc.). UE 115-a may receive the minimum SI 205 from base station 105-a. The minimum SI 205 may provide scheduling information for other SI 210, including SIB type, validity information, SI periodicity, SI window information, etc. The minimum SI 205 may further include an indicator, which the UE 115-a may use to identify whether a particular SI-block is periodically broadcasted or provided on-demand. For example, the scheduling information in the minimum SI 205 may include an indicator identifying whether a SI-block is periodically broadcasted or provided on demand. Therefore, after UE 115-a sends a SI request (e.g., for a requested SIB), UE 115-a may monitor the SI window of the requested SIB in one or more SI periodicities of that SIB.

In some cases, some wireless communications systems may have fixed MSIB and OSIB scheduling, such that all SIBs are broadcast to UEs within a cell. However, this may result in increased, for example including unnecessary, OTA signaling. In other cases, SI may be divided into MSIB and a number of SIBs that are broadcast periodically according to a predetermined periodicity (e.g., configured by the network). SI from MSIB to SIBS may include radio parameters for a UE 115 to access a cell (e.g., including cell reselection). Remaining SI (e.g., SIB6 and on, excluding SIB10, SIB11, and SIB12) may include information relating to, for example, inter-RAT cell reselection, MBMS, WLAN, sidelink, etc.

As such, wireless communications system 200 may support techniques for system information updating for cellular systems. Specifically, transmission mechanisms may be altered or adjusted such that SI (e.g., other SI) may be broadcast type for a certain time interval T based on certain conditions being satisfied, described in more detail below. Outside of the interval T (for example before time duration T, after time duration T, or both), wireless communications system 200 may revert to on-demand transmission of such SI. In some cases, the broadcast (e.g., during the interval T) may include the OSIB or may include OSIB padded along with MSIB. An indication (e.g., a “SI change in Other SI” indication, an indication of a cause, for example in a paging message, etc.) may be sent to UEs 115 that SI is changed for OSIB, all affected SI may be broadcast for the T duration.

Broadcasting SI in such a manner may improve network efficiency (e.g., by broadcasting SI for a duration T, and then reverting back to unicast mode outside the interval T). As such, new SI change cause and sub cause information elements may reduce the impact on UEs 115 not interested in certain OSIB (e.g., SI change cause and/or sub cause information elements may indicate a SIB type, such that UEs 115 do not receive unneeded or redundant information that may be present in certain OSIBs) and may also seek to ensure that all interested UEs 115 may receive updated SI. Further, a sub cause may be added to the indication or paging message, which may indicate specific SI change, as well as the criticality or priority of the change. As such, quick accessibility, mobility, and recovery from out of service and state transition latency as updated critical SI are available.

Scenarios where techniques for system information updating for cellular systems may be implemented are now described in more detail. As a first example, when there is a SI parameter update, base station 105-a may broadcast SI alone, or may pad SI with MSIB and broadcast the MSIB with the “SI change in Other SI” indicator to all UEs 115 (e.g., including UE 115-a) for a predetermined period of time T (e.g., Tₛₕₒᵣₜ). When the network (e.g., via base station 105-a) receives multiple requests (e.g., from multiple UEs 115) for the same OSIB, or multiple requests for a few OSIBs, the base station 105-a may pad an OSIB or multiple OSIBs with an MSIB and broadcast with an indicator (e.g., a “SI change in Other SI” indicator, indicating the OSIB/OSIBs) to all UEs 115 for a predetermined period of time T (e.g., Tₛₕₒᵣₜ) or the base station 105-a may broadcast OSIB/OSIBs alone during the predetermined period of time T (e.g., Tₛₕₒᵣₜ). Furthermore, changes to the status of base station 105-a like neighbor cell information, quality of service (QoS) of neighbor cells, access barring information, etc. may also trigger implementation of such techniques, including setting the time duration T for the transmission of broadcast SIBs that include updated or modified SI.

For example, when there are critical SI parameter updates, the base station 105-a may broadcast modified SIBs within the time period T. If there is a change in SI parameters of Other SI 210, all UEs 115 in the cell may need to update the changed SI parameters. Instead of all UEs 115 requesting for updated SI and wasting network resources, the base station 105-a may broadcast modified SIBs and indicate the SI change in Other SI to all UEs 115 for a predetermined time period T (e.g., Tₛₕₒᵣₜ). UEs 115 which are looking for Other SI may read the broadcast SI message. As such, power savings may be realized for UEs 115 that are not looking for Other SI as well as efficient resource utilization over dedicated SI transmission.

In another example, when any neighbor base station 105 status changes, the base station 105-a may broadcast modified SIBs within the time period T. Such status changes may include a new neighbor cell coming up or becoming available, a neighbor cell powering down or becoming unavailable, a change in frequency of neighbor cells, change in QoS of neighbor cells, a change in Access Barring information, etc. In some cases, predetermined types of SIBs (e.g., SIBS and SIB6) may carry such neighbor cell information. Such information may be used by UE 115-a to maintain connectivity by reselections, handover, and may reduce instances of radio link failure (RLF). Therefore, this SI (e.g., these SIBs) may be switched to broadcast type transmission, and broadcast during a certain time duration T, to ensure all affected UEs 115 read the SI and then revert to on-demand transmission type (e.g., unicast).

In yet another example, when in a single time window, W, base station 105-a receives multiple Other SI requests from multiple UEs 115, the base station 105-a may broadcast modified SIBs within the time period T. For example, consider a scenario with four UEs 115 (e.g., UE1, UE2, UE3, and UE4) where UE1 sends an SI request for SIB-x, base station 105-a receives the SIB-x request from UE1 and starts a timer T for broadcast of SIB-x. Subsequently, UE2 sends SI request for SIB-y, UE3 sends SI request for SIB-z, and UE4 sends SI request for SIB-y. If all the other SI requests (e.g., from UE2, UE3, and UE4) are received by base station 105-a within the duration of time duration T, and prior to expiry of a timer (e.g., a timer that was started when the first SI request was received from UE1), the base station 105-a may broadcast the SIBs (e.g., SIB-x, SIB-y, SIB-z). In some cases, the base station 105-b may include SIB-x, SIB-y, and SIB-z in Minimum SI and broadcast (e.g., for Mₘᵢₙ times) and then remove SIB-x, SIB-y, and SIB-z from Minimum SI. In other cases, base station 105-a, may create a new SI Block (e.g., like Minimum SI) with SIB-x, SIB-y, and SIB-z and broadcast the new SI Block (e.g., for Mₘᵢₙ times). In yet other cases, the base station 105-a may selectively include some SIBs in Minimum SI or New SI (e.g., SIB-y in the present example, as the base station 105-a received multiple requests for SIB-y) to be broadcast, and other SIBs may be unicast transmission type (e.g., SIB-x and SIB-y in the present example). Therefore, faster and more efficient SI transmission may be realized, and the number or amount of OTA signaling may be reduced.

As a final example, when a periodicity T of a MSIB is high or when the number of UEs 115 within a cell is high (e.g., thirty or more UEs 115), the base station 105-a may broadcast modified SIBs within the time period T. When a MSIB periodicity T is large, the probability of the number of Other SI requests from UEs 115 may increase. When the number of UEs 115 within the cell increase, the number or amount of OTA signaling for on-demand SI information may also increase. Therefore, in such scenarios, it may be more efficient to fallback to broadcast mode for certain times, or for a certain number of frames, and revert to unicast mode.

Implementation of the techniques above may result in reduced OTA signaling and increased SI signaling efficiency. UEs 115 may be updated with changing SIB values more effectively as needed. As such, correct SI may be conveyed to UEs 115 within the system with reduced signaling to a maximum UEs 115 being affected, with no additional hardware cost. Further, power limited (e.g., battery critical) UEs 115 may be assisted via OTA reduction and reduced wakeup times.

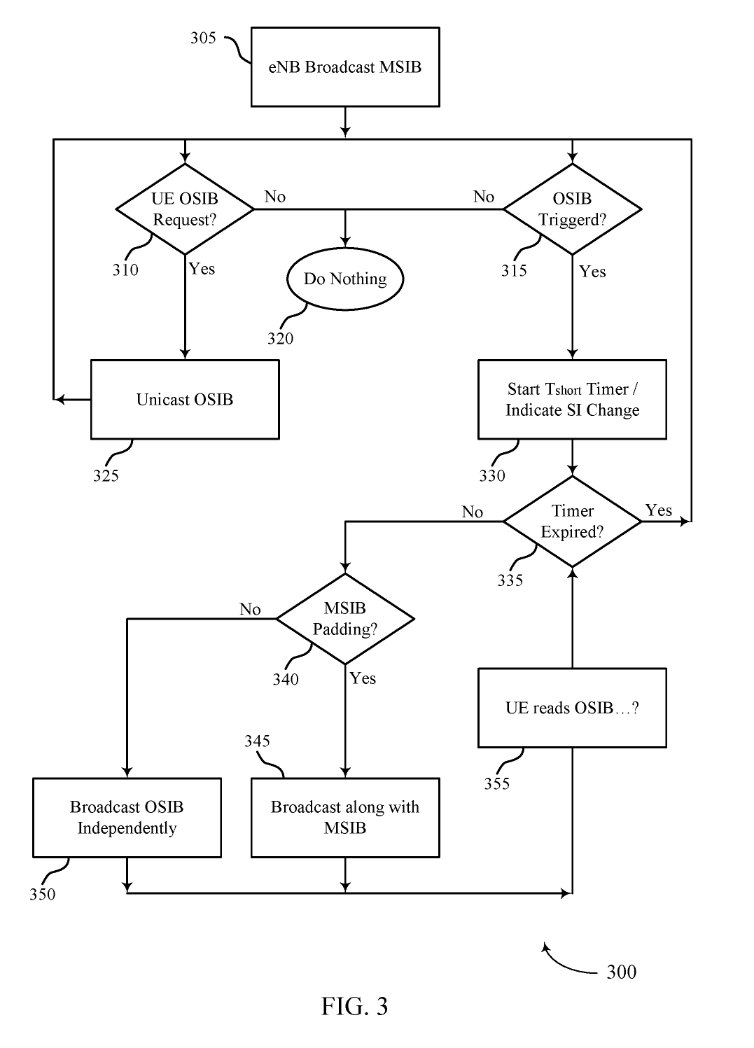

FIG. 3 illustrates an example of a process flow 300 that supports improved system information updating for cellular systems in accordance with various aspects of the present disclosure. In some examples, process flow 300 may implement aspects of wireless communications system 100 (e.g., illustrate aspects of techniques as performed by a UE 115 and/or a base station 105). At 305, a base station 105 may broadcast MSIBs periodically (e.g., during a time interval T). If there is an OSIB request from a UE 115 (e.g., at 310), the base station may transmit a unicast OSIB (e.g., SIBs associated with the request) to the UE 115. For example, a UE 115 may have missed some information or specifically desire update of certain SI, in such cases, the UE 115 may transmit an OSIB request (e.g., SIB-x request) to the base station 105, and the base station 105 may unicast the requested SI (e.g., SIB-x) at 325.

Alternatively, if there is any change in OSIB information or if scenarios discussed above that call for the base station 105 to broadcast modified SIBs within the time period T, the network or base station 105 may start or initiate a Tₛₕₒᵣₜ timer and indicate a “SI change in Other SI” to all UEs 115 (e.g., at 330). As discussed in more detail above (e.g., with reference to FIG. 2), such scenarios may include, for example, a network change in OSIB information or several or many UEs 115 requesting the same Other SI (e.g., the same OSIB). While the Tₛₕₒᵣₜ timer is running, the network may be in the broadcast mode or interval broadcast mode according to the present disclosure. In some cases, the duration of the Tₛₕₒᵣₜ timer may depend on the size of the cell or the number of UEs within the cell. Further, the duration of the Tₛₕₒᵣₜ timer may be dynamic or may be updated according to, for example, repetition rate of the SIBs (e.g., which may be different for different SIBs), the criticality of the SIBs, etc. The indication may be included in the MSIB or the OSIB. In some cases, whether the indication is included in the MSIB or OSIB may indicate criticality of the information, which may be the priority of the system information relative to other system information. In any case, the network may indicate the criticality to the UEs 115, such that the UEs 115 may determine whether or not to continue with reception of the broadcast OSIBs.

The base station may determine whether or not the new SI (e.g., the new OSIB information) may be padded with MSIB. If it cannot (e.g., the amount of new OSIB information is too large), the base station may broadcast the OSIB information alone (e.g., during the interval T) at 350. However, if the new OSIB information can be padded with MSIB, the base station 105 may broadcast the new OSIB information along with the MSIB (e.g., during the interval T) at 345.

At 355, some or all UEs 115 may read the OSIB indicating SI change. That is, at 355, UEs may read the “SI change in Other SI” indication and, based on the information in cause and sub cause elements, read the new OSIB information if so desired. For example, a UE 115 may determine whether or not to read or receive the OSIB based on the criticality indicated by, for example, a sub cause of the indication or paging message. In some cases, the scenario identified at 315 may be included in a cause or sub cause of the indicator. UEs not interested (e.g., legacy UEs) may interpret such portions of the indicator and disregard the subsequent OSIBs.

After 355 (or in some cases after 330), if the timer (e.g., Tₛₕₒᵣₜ) has expired, the network may resume operation according to techniques described herein (e.g., broadcasting MSIBs during interval T, with unicast OSIBs available on demand outside of the interval T).

If no UEs 115 request OSIBs, there is no change in OSIB, and none of the conditions for modified SIB broadcast are satisfied, there may be no additional action (e.g., at 320) and the base station may resume operations of 305 until one of the conditions of 310 and/or 315 occur.

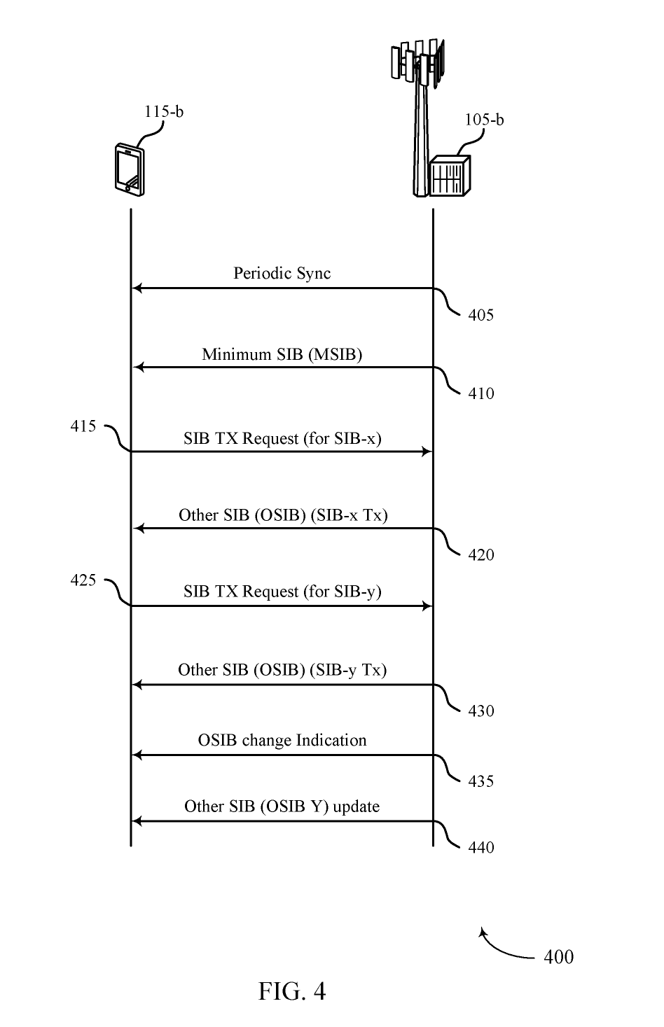

FIG. 4 illustrates an example of a process flow 400 that supports improved system information updating for cellular systems in accordance with various aspects of the present disclosure. In some examples, process flow 400 may implement aspects of wireless communications system 100.

At 405, base station 105-b may synch with UE 115-b (e.g., according to some periodicity).

At 410, base station 105-b may transmit an MSIB to UE 115-b. For example, the MSIB may be transmitted periodically according some interval T, as described herein.

Outside of the interval T, the UE 115-b may transmit a request for other SI (e.g., SIB-x) at 415. At 420, base station 105-b may unicast the requested information (e.g., SIB-x) to UE 115-b.

At 425, the UE 115-b may transmit a request for other SI (e.g., SIB-y, outside of the interval T). At 430, base station 105-b may unicast the requested information (e.g., SIB-y) to UE 115-b.

At 435, base station 105-b may transmit an indication that there is a change in OSIB information. As discussed above, the indication may include a cause and sub cause indicating the criticality or priority of the information change. In some cases, multiple UEs 115 may request certain other SI. For example, if base station 105-b receives multiple requests for certain SI (e.g., if multiple UEs 115 request SIB-y, multiple 425 requests from different UEs), the base station 105-b may indicate a change in SIB-y information at 435. In such cases, base station 105-b may or may not perform step 430, as UE 115-b may receive the SIB-y via 440.

That is, in the scenario where multiple UEs 115 have requested SIB-y in the recent past (e.g., within some predetermined time interval, since the last MSIB broadcast, etc.) or if there is an update to SIB-y, the base station 105-b may defer any unicast transmissions to instead broadcast SIB-y (e.g., independently or padded with MSIB). Base station 105-b may broadcast SIB-y independently for a time T, or may include SIB-y in the MSIB and broadcast the MSIB and SIB-y together during a time T. Transmitting the MSIB and SIB-y together may reduce latency of the SI transmission (e.g., future UEs 115 may receive updated SIB-y before having to transmit a request, UEs 115 that have transmitted a request may not have to wait for unicast transmission resources to become available, etc.). Further, multiple SI requests coming from multiple UEs 115 (e.g., that have not yet transmitted a request, or that are transmitting second or additional requests) may be reduced which may result in increased power optimization for power limited UEs 115.

At 440, base station 105-b may transmit the other SI (e.g., SIB-y) update. In some cases the one or more OSIBs may be padded with MSIB and broadcasted or, in other cases, broadcast independently (e.g., as described with reference to FIG. 3). UE 115-b may determine whether or not to receive the updated OSIB based on the cause and or sub cause of the indication received at 435.

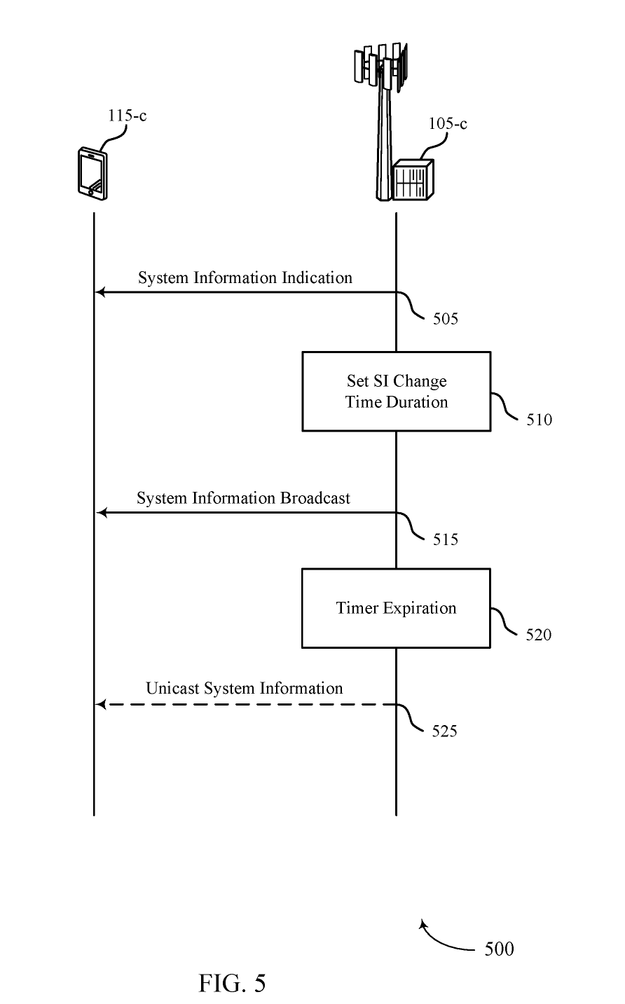

FIG. 5 illustrates an example of a process flow 500 that supports improved system information updating for cellular systems in accordance with various aspects of the present disclosure. In some examples, process flow 500 may implement aspects of wireless communications system 100.

At 505, base station 105-c may transmit an indication of a SI change to UE 115-c.

At 510, base station 105-c may, based on transmitting the indication at 505, set a time duration for the SI change.

At 515, base station 105-c may broadcast, during the time duration and based on the SI change, one or more information blocks (e.g., indicating the SI change).

At 520, the timer associated with the time duration set at 510 may expire at the base station 105-c (e.g., a certain time duration may have elapsed or expired).

At 525, base station 105-c may return to transmitting the SI based according to the first transmission type (e.g., prior to the SI change indication). In some cases, base station 105-c may return to the first transmission type based on expiration of the timer at 520. In some cases, the transmission type may be an on-demand unicast transmission type.

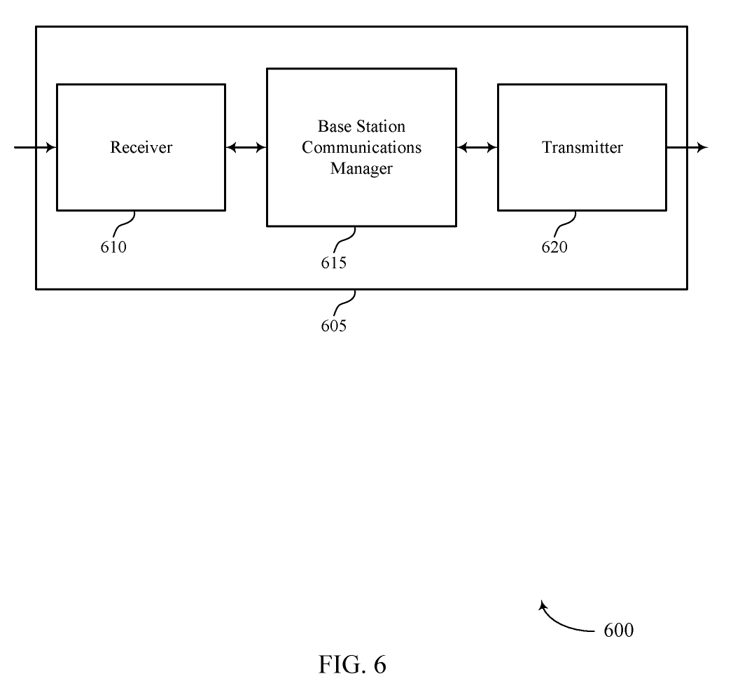

FIG. 6 shows a block diagram 600 of a wireless device 605 that supports improved system information updating for cellular systems in accordance with aspects of the present disclosure. Wireless device 605 may be an example of aspects of a base station 105 as described herein. Wireless device 605 may include receiver 610, base station communications manager 615, and transmitter 620. Wireless device 605 may also include a processor. Each of these components may be in communication with one another (e.g., via one or more buses).

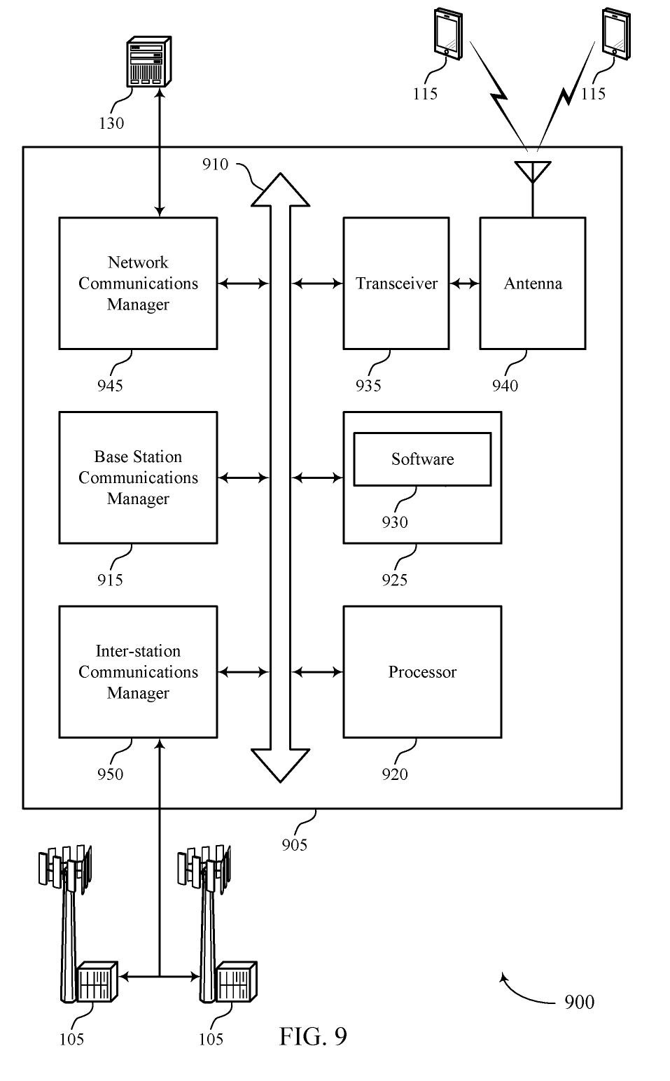

Receiver 610 may receive information such as packets, user data, or control information associated with various information channels (e.g., control channels, data channels, and information related to improved system information updating for cellular systems, etc.). Information may be passed on to other components of the device. The receiver 610 may be an example of aspects of the transceiver 935 described with reference to FIG. 9. The receiver 610 may utilize a single antenna or a set of antennas.

Base station communications manager 615 may be an example of aspects of the base station communications manager 915 described with reference to FIG. 9.

Base station communications manager 615 and/or at least some of its various sub-components may be implemented in hardware, software executed by a processor, firmware, or any combination thereof. If implemented in software executed by a processor, the functions of the base station communications manager 615 and/or at least some of its various sub-components may be executed by a general-purpose processor, a digital signal processor (DSP), an application-specific integrated circuit (ASIC), an field-programmable gate array (FPGA) or other programmable logic device, discrete gate or transistor logic, discrete hardware components, or any combination thereof designed to perform the functions described in the present disclosure. The base station communications manager 615 and/or at least some of its various sub-components may be physically located at various positions, including being distributed such that portions of functions are implemented at different physical locations by one or more physical devices. In some examples, base station communications manager 615 and/or at least some of its various sub-components may be a separate and distinct component in accordance with various aspects of the present disclosure. In other examples, base station communications manager 615 and/or at least some of its various sub-components may be combined with one or more other hardware components, including but not limited to an I/O component, a transceiver, a network server, another computing device, one or more other components described in the present disclosure, or a combination thereof in accordance with various aspects of the present disclosure.

Base station communications manager 615 may transmit, to a UE, an indication of a system information change, set, based on transmitting the indication, a time duration for the system information change, broadcast, during the time duration and based on the system information change, one or more of a first type of information block, and return, based on an expiration of the time duration, to transmitting the first type of information block to the UE in response to one or more requests from the UE.

Transmitter 620 may transmit signals generated by other components of the device. In some examples, the transmitter 620 may be collocated with a receiver 610 in a transceiver module. For example, the transmitter 620 may be an example of aspects of the transceiver 935 described with reference to FIG. 9. The transmitter 620 may utilize a single antenna or a set of antennas.

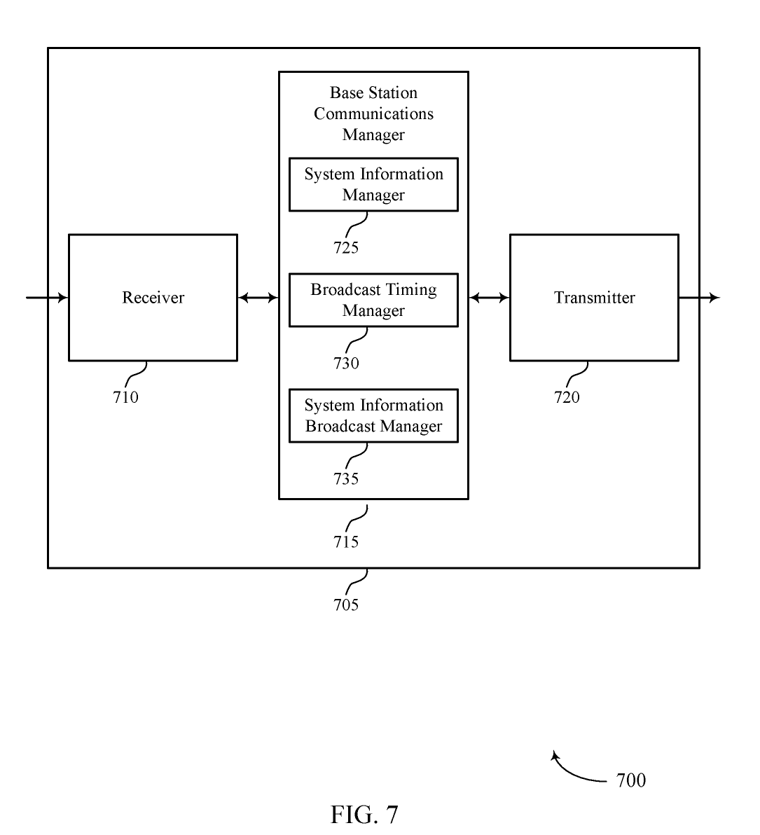

FIG. 7 shows a block diagram 700 of a wireless device 705 that supports improved system information updating for cellular systems in accordance with aspects of the present disclosure. Wireless device 705 may be an example of aspects of a wireless device 605 or a base station 105 as described with reference to FIG. 6. Wireless device 705 may include receiver 710, base station communications manager 715, and transmitter 720. Wireless device 705 may also include a processor. Each of these components may be in communication with one another (e.g., via one or more buses).

Receiver 710 may receive information such as packets, user data, or control information associated with various information channels (e.g., control channels, data channels, and information related to improved system information updating for cellular systems, etc.). Information may be passed on to other components of the device. The receiver 710 may be an example of aspects of the transceiver 935 described with reference to FIG. 9. The receiver 710 may utilize a single antenna or a set of antennas.

Base station communications manager 715 may be an example of aspects of the base station communications manager 915 described with reference to FIG. 9. Base station communications manager 715 may also include system information manager 725, broadcast timing manager 730, and system information broadcast manager 735.

System information manager 725 may transmit, to a UE, an indication of a system information change and return, based on an expiration of the time duration, to transmitting the first type of information block to the UE in response to one or more requests from the UE. In some cases, transmitting the indication of the system information change includes: transmitting a paging message, the paging message including a cause field indicating the system information change, or an information block type, or a combination thereof.

Broadcast timing manager 730 may set, based on transmitting the indication, a time duration for the system information change.

System information broadcast manager 735 may broadcast, during the time duration and based on the system information change, one or more of a first type of information block and broadcast a second type of information block, where the second type of information block includes information for at least one of the one or more of the first type of information block. In some cases, broadcasting the one or more of the first type of information block includes broadcasting a first of the first type of information block together with at least one other of the first type of information block. In some cases, broadcasting the one or more of the first type of information block includes broadcasting a first of the first type of information block together with a second type of information block. In some cases, the first type of information block is an OSIB. In some cases, the second type of information block is a MSIB. In some cases, the first type of information block is associated with a first repetition rate and the second type of information block is associated with a second repetition rate. In some cases, the information for at least one of the one or more of the first type of information block includes an indicator to identify the one or more of the first type of information block as periodic or as provided on request, a type, or a validity, or a periodicity, or a window, or a combination thereof.

Transmitter 720 may transmit signals generated by other components of the device. In some examples, the transmitter 720 may be collocated with a receiver 710 in a transceiver module. For example, the transmitter 720 may be an example of aspects of the transceiver 935 described with reference to FIG. 9. The transmitter 720 may utilize a single antenna or a set of antennas.

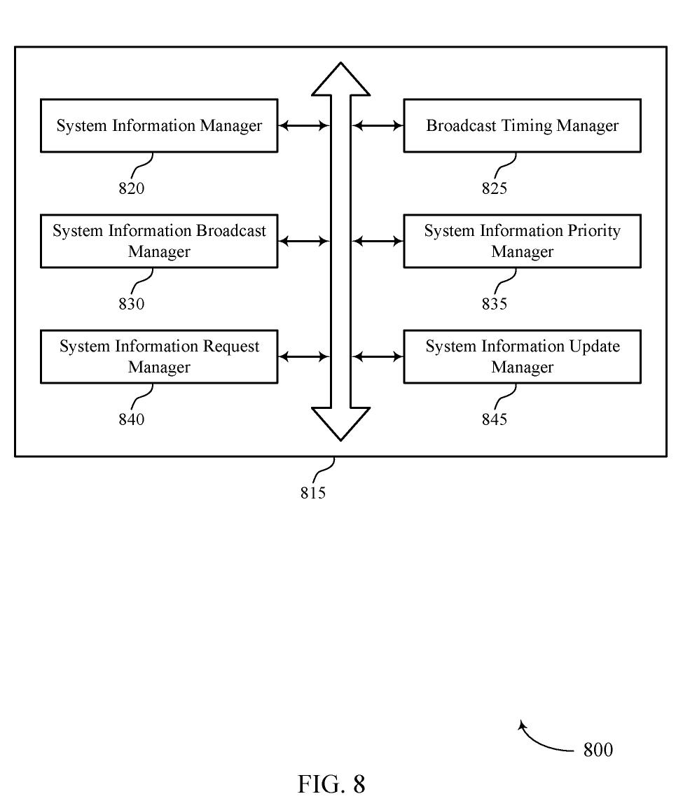

FIG. 8 shows a block diagram 800 of a base station communications manager 815 that supports improved system information updating for cellular systems in accordance with aspects of the present disclosure. The base station communications manager 815 may be an example of aspects of a base station communications manager 615, a base station communications manager 715, or a base station communications manager 915 described with reference to FIGS. 6, 7, and 9. The base station communications manager 815 may include system information manager 820, broadcast timing manager 825, system information broadcast manager 830, system information priority manager 835, system information request manager 840, and system information update manager 845. Each of these modules may communicate, directly or indirectly, with one another (e.g., via one or more buses).

System information manager 820 may transmit, to a UE, an indication of a system information change and return, based on an expiration of the time duration, to transmitting the first type of information block to the UE in response to one or more requests from the UE. In some cases, transmitting the indication of the system information change includes transmitting a paging message, the paging message including a cause field indicating the system information change, or an information block type, or a combination thereof.

Broadcast timing manager 825 may set, based on transmitting the indication, a time duration for the system information change.

System information broadcast manager 830 may broadcast, during the time duration and based on the system information change, one or more of a first type of information block and broadcast a second type of information block, where the second type of information block includes information for at least one of the one or more of the first type of information block. In some cases, broadcasting the one or more of the first type of information block includes broadcasting a first of the first type of information block together with at least one other of the first type of information block. In some cases, broadcasting the one or more of the first type of information block includes broadcasting a first of the first type of information block together with a second type of information block. In some cases, the first type of information block is an OSIB. In some cases, the second type of information block is a MSIB. In some cases, the first type of information block is associated with a first repetition rate and the second type of information block is associated with a second repetition rate. In some cases, the information for at least one of the one or more of the first type of information block includes an indicator to identify the one or more of the first type of information block as periodic or as provided on request, a type, or a validity, or a periodicity, or a window, or a combination thereof.

System information priority manager 835 may transmit, to the UE, an indication of a priority of the system information change.

System information request manager 840 may receive a set of requests to transmit the first type of information block from a set of UEs served by the base station and identify that a number of the set of requests satisfy a threshold, where the indication of the system information change is transmitted based on the identification.

System information update manager 845 may identify the system information change, where the base station includes a first cell, and the system information change is a change in information for a second cell. In some cases, system information update manager 845 may identify a status of the second cell, a frequency of the second cell, a quality of service setting for the second cell, or an access barring information, or a combination thereof. For example, where the second cell is a neighbor cell (e.g., the first cell is a serving cell), the change in information may be a change in information for the neighbor cell, a status change of the neighbor cell, a change in frequency of the neighbor cell, a change in QoS of the neighbor cell, etc.

FIG. 9 shows a diagram of a system 900 including a device 905 that supports improved system information updating for cellular systems in accordance with aspects of the present disclosure. Device 905 may be an example of or include the components of wireless device 605, wireless device 705, or a base station 105 as described above, e.g., with reference to FIGS. 6 and 7. Device 905 may include components for bi-directional voice and data communications including components for transmitting and receiving communications, including base station communications manager 915, processor 920, memory 925, software 930, transceiver 935, antenna 940, network communications manager 945, and inter-station communications manager 950. These components may be in electronic communication via one or more buses (e.g., bus 910). Device 905 may communicate wirelessly with one or more UEs 115.

Processor 920 may include an intelligent hardware device, (e.g., a general-purpose processor, a DSP, a central processing unit (CPU), a microcontroller, an ASIC, an FPGA, a programmable logic device, a discrete gate or transistor logic component, a discrete hardware component, or any combination thereof). In some cases, processor 920 may be configured to operate a memory array using a memory controller. In other cases, a memory controller may be integrated into processor 920. Processor 920 may be configured to execute computer-readable instructions stored in a memory to perform various functions (e.g., functions or tasks supporting improved system information updating for cellular systems).

Memory 925 may include random access memory (RAM) and read only memory (ROM). The memory 925 may store computer-readable, computer-executable software 930 including instructions that, when executed, cause the processor to perform various functions described herein. In some cases, the memory 925 may contain, among other things, a basic input/output system (BIOS) which may control basic hardware or software operation such as the interaction with peripheral components or devices.

Software 930 may include code to implement aspects of the present disclosure, including code to support improved system information updating for cellular systems. Software 930 may be stored in a non-transitory computer-readable medium such as system memory or other memory. In some cases, the software 930 may not be directly executable by the processor but may cause a computer (e.g., when compiled and executed) to perform functions described herein.

Transceiver 935 may communicate bi-directionally, via one or more antennas, wired, or wireless links as described above. For example, the transceiver 935 may represent a wireless transceiver and may communicate bi-directionally with another wireless transceiver. The transceiver 935 may also include a modem to modulate the packets and provide the modulated packets to the antennas for transmission, and to demodulate packets received from the antennas.

In some cases, the wireless device may include a single antenna 940. However, in some cases the device may have more than one antenna 940, which may be capable of concurrently transmitting or receiving multiple wireless transmissions.

Network communications manager 945 may manage communications with the core network (e.g., via one or more wired backhaul links). For example, the network communications manager 945 may manage the transfer of data communications for client devices, such as one or more UEs 115.

Inter-station communications manager 950 may manage communications with other base station 105, and may include a controller or scheduler for controlling communications with UEs 115 in cooperation with other base stations 105. For example, the inter-station communications manager 950 may coordinate scheduling for transmissions to UEs 115 for various interference mitigation techniques such as beamforming or joint transmission. In some examples, inter-station communications manager 950 may provide an X2 interface within a Long Term Evolution (LTE)/LTE-A wireless communication network technology to provide communication between base stations 105.

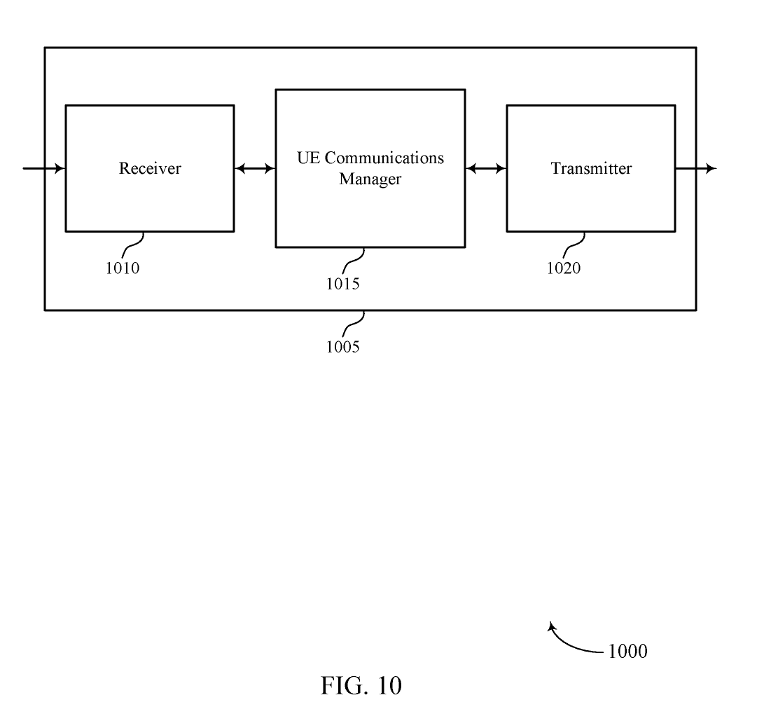

FIG. 10 shows a block diagram 1000 of a wireless device 1005 that supports improved system information updating for cellular systems in accordance with aspects of the present disclosure. Wireless device 1005 may be an example of aspects of a UE 115 as described herein. Wireless device 1005 may include receiver 1010, UE communications manager 1015, and transmitter 1020. Wireless device 1005 may also include a processor. Each of these components may be in communication with one another (e.g., via one or more buses).

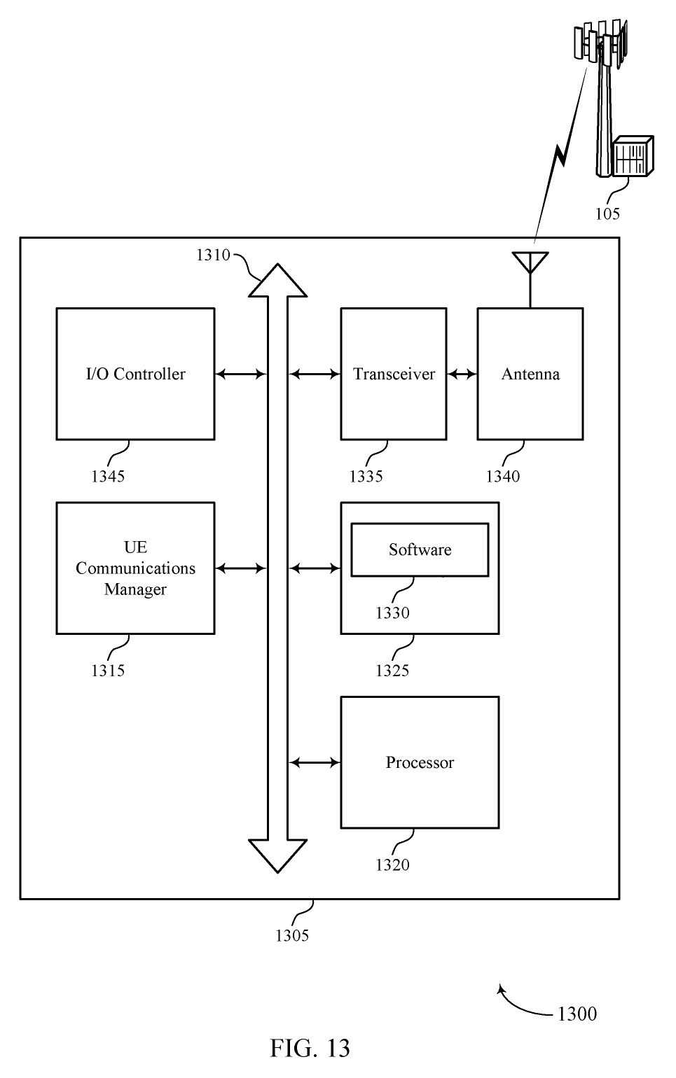

Receiver 1010 may receive information such as packets, user data, or control information associated with various information channels (e.g., control channels, data channels, and information related to improved system information updating for cellular systems, etc.). Information may be passed on to other components of the device. The receiver 1010 may be an example of aspects of the transceiver 1335 described with reference to FIG. 13. The receiver 1010 may utilize a single antenna or a set of antennas.

UE communications manager 1015 may be an example of aspects of the UE communications manager 1315 described with reference to FIG. 13.

UE communications manager 1015 and/or at least some of its various sub-components may be implemented in hardware, software executed by a processor, firmware, or any combination thereof. If implemented in software executed by a processor, the functions of the UE communications manager 1015 and/or at least some of its various sub-components may be executed by a general-purpose processor, a DSP, an ASIC, an FPGA or other programmable logic device, discrete gate or transistor logic, discrete hardware components, or any combination thereof designed to perform the functions described in the present disclosure. The UE communications manager 1015 and/or at least some of its various sub-components may be physically located at various positions, including being distributed such that portions of functions are implemented at different physical locations by one or more physical devices. In some examples, UE communications manager 1015 and/or at least some of its various sub-components may be a separate and distinct component in accordance with various aspects of the present disclosure. In other examples, UE communications manager 1015 and/or at least some of its various sub-components may be combined with one or more other hardware components, including but not limited to an I/O component, a transceiver, a network server, another computing device, one or more other components described in the present disclosure, or a combination thereof in accordance with various aspects of the present disclosure.

UE communications manager 1015 may receive, from a base station, an indication of a system information change, and set, based on the received indication, a time duration for the system information change. UE communications manager 1015 may receive, during the time duration and based on the indication of the system information change, one or more of a first type of information block broadcast by the base station, and return, based on an expiration of the time duration, to monitoring for the first type of information block transmitted to the UE from the base station.

Transmitter 1020 may transmit signals generated by other components of the device. In some examples, the transmitter 1020 may be collocated with a receiver 1010 in a transceiver module. For example, the transmitter 1020 may be an example of aspects of the transceiver 1335 described with reference to FIG. 13. The transmitter 1020 may utilize a single antenna or a set of antennas.

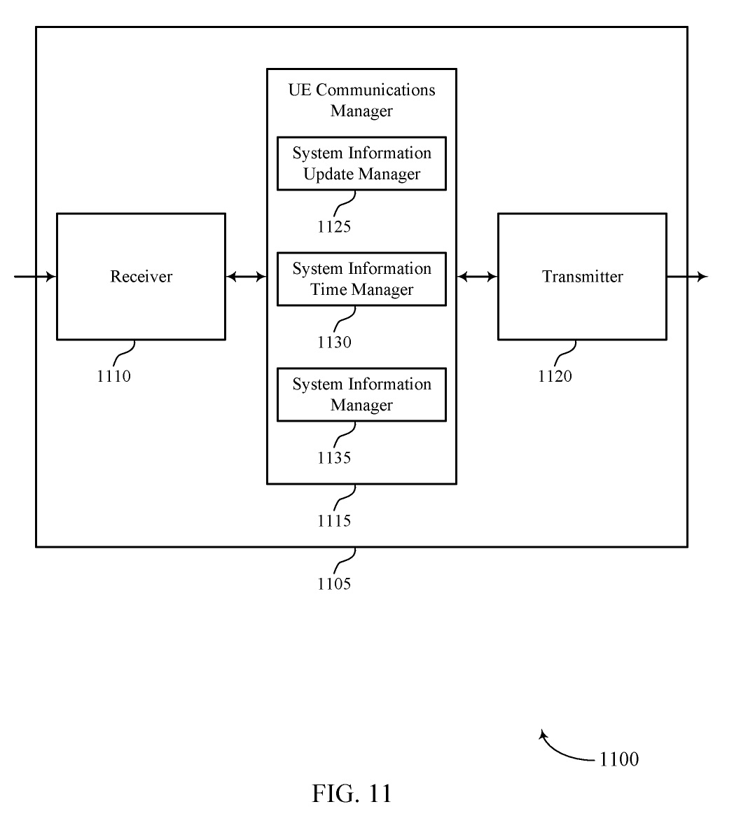

FIG. 11 shows a block diagram 1100 of a wireless device 1105 that supports improved system information updating for cellular systems in accordance with aspects of the present disclosure. Wireless device 1105 may be an example of aspects of a wireless device 1005 or a UE 115 as described with reference to FIG. 10. Wireless device 1105 may include receiver 1110, UE communications manager 1115, and transmitter 1120. Wireless device 1105 may also include a processor. Each of these components may be in communication with one another (e.g., via one or more buses).

Receiver 1110 may receive information such as packets, user data, or control information associated with various information channels (e.g., control channels, data channels, and information related to improved system information updating for cellular systems, etc.). Information may be passed on to other components of the device. The receiver 1110 may be an example of aspects of the transceiver 1335 described with reference to FIG. 13. The receiver 1110 may utilize a single antenna or a set of antennas.

UE communications manager 1115 may be an example of aspects of the UE communications manager 1315 described with reference to FIG. 13. UE communications manager 1115 may also include system information update manager 1125, system information time manager 1130, and system information manager 1135.

System information update manager 1125 may receive, from a base station, an indication of a system information change.

System information time manager 1130 may set, based on the received indication, a time duration for the system information change.

System information manager 1135 may receive, during the time duration and based on the indication of the system information change, one or more of a first type of information block broadcast by the base station, and return, based on an expiration of the time duration, to monitoring for the first type of information block transmitted to the UE from the base station. System information manager 1135 may receive a second type of information block, where the second type of information block includes information for at least one of the one or more of the first type of information block. In some cases, the one or more of the first type of information block broadcast by the base station is received based on the request. In some cases, receiving the one or more of the first type of information block includes receiving, from the base station, a first of the first type of information block together with at least one other of the first type of information block. In some cases, receiving the one or more of the first type of information block includes receiving, from the base station, a first of the first type of information block together with a second type of information block. In some cases, the information for at least one of the one or more of the first type of information block includes an indicator to identify the one or more of the first type of information block as periodic or as provided on request, a type, or a validity, or a periodicity, or a window, or a combination thereof. In some cases, the first type of information block is an OSIB. In some cases, the second type of information block is a MSIB. In some cases, the first type of information block is associated with a first repetition rate and the second type of information block is associated with a second repetition rate.

Transmitter 1120 may transmit signals generated by other components of the device. In some examples, the transmitter 1120 may be collocated with a receiver 1110 in a transceiver module. For example, the transmitter 1120 may be an example of aspects of the transceiver 1335 described with reference to FIG. 13. The transmitter 1120 may utilize a single antenna or a set of antennas.

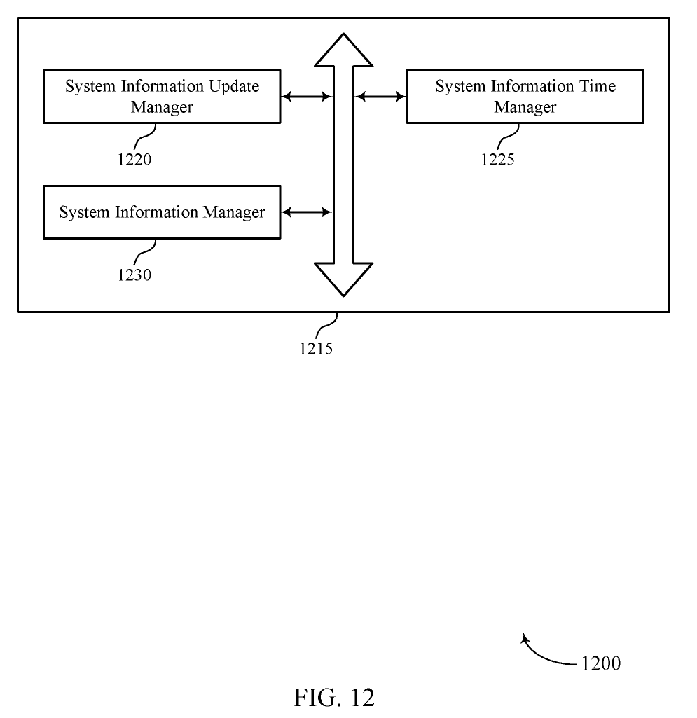

FIG. 12 shows a block diagram 1200 of a UE communications manager 1215 that supports improved system information updating for cellular systems in accordance with aspects of the present disclosure. The UE communications manager 1215 may be an example of aspects of a UE communications manager 1315 described with reference to FIGS. 10, 11, and 13. The UE communications manager 1215 may include system information update manager 1220, system information time manager 1225, and system information manager 1230. Each of these modules may communicate, directly or indirectly, with one another (e.g., via one or more buses).

System information update manager 1220 may receive, from a base station, an indication of a system information change.

System information time manager 1225 may set, based on the received indication, a time duration for the system information change.

System information manager 1230 may receive, during the time duration and based on the indication of the system information change, one or more of a first type of information block broadcast by the base station. System information manager 1230 may return, based on an expiration of the time duration, to monitoring for the first type of information block transmitted to the UE from the base station, and receive a second type of information block, where the second type of information block includes information for at least one of the one or more of the first type of information block. In some cases, the one or more of the first type of information block broadcast by the base station is received based on the request. In some cases, receiving the one or more of the first type of information block includes receiving, from the base station, a first of the first type of information block together with at least one other of the first type of information block. In some cases, receiving the one or more of the first type of information block includes receiving, from the base station, a first of the first type of information block together with a second type of information block. In some cases, the information for at least one of the one or more of the first type of information block includes an indicator to identify the one or more of the first type of information block as periodic or as provided on request, a type, or a validity, or a periodicity, or a window, or a combination thereof. In some cases, the first type of information block is an OSIB. In some cases, the second type of information block is a MSIB.

FIG. 13 shows a diagram of a system 1300 including a device 1305 that supports improved system information updating for cellular systems in accordance with aspects of the present disclosure. Device 1305 may be an example of or include the components of UE 115 as described above, e.g., with reference to FIG. 1. Device 1305 may include components for bi-directional voice and data communications including components for transmitting and receiving communications, including UE communications manager 1315, processor 1320, memory 1325, software 1330, transceiver 1335, antenna 1340, and I/O controller 1345. These components may be in electronic communication via one or more buses (e.g., bus 1310). Device 1305 may communicate wirelessly with one or more base stations 105.

Processor 1320 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, processor 1320 may be configured to operate a memory array using a memory controller. In other cases, a memory controller may be integrated into processor 1320. Processor 1320 may be configured to execute computer-readable instructions stored in a memory to perform various functions (e.g., functions or tasks supporting improved system information updating for cellular systems).

Memory 1325 may include RAM and ROM. The memory 1325 may store computer-readable, computer-executable software 1330 including instructions that, when executed, cause the processor to perform various functions described herein. In some cases, the memory 1325 may contain, among other things, a BIOS which may control basic hardware or software operation such as the interaction with peripheral components or devices.

Software 1330 may include code to implement aspects of the present disclosure, including code to support improved system information updating for cellular systems. Software 1330 may be stored in a non-transitory computer-readable medium such as system memory or other memory. In some cases, the software 1330 may not be directly executable by the processor but may cause a computer (e.g., when compiled and executed) to perform functions described herein.

Transceiver 1335 may communicate bi-directionally, via one or more antennas, wired, or wireless links as described above. For example, the transceiver 1335 may represent a wireless transceiver and may communicate bi-directionally with another wireless transceiver. The transceiver 1335 may also include a modem to modulate the packets and provide the modulated packets to the antennas for transmission, and to demodulate packets received from the antennas.

In some cases, the wireless device may include a single antenna 1340. However, in some cases the device may have more than one antenna 1340, which may be capable of concurrently transmitting or receiving multiple wireless transmissions.

I/O controller 1345 may manage input and output signals for device 1305. I/O controller 1345 may also manage peripherals not integrated into device 1305. In some cases, I/O controller 1345 may represent a physical connection or port to an external peripheral. In some cases, I/O controller 1345 may utilize an operating system such as iOS®, ANDROID®, MS-DOS®, MS-WINDOWS®, OS/2®, UNIX®, LINUX®, or another known operating system. In other cases, I/O controller 1345 may represent or interact with a modem, a keyboard, a mouse, a touchscreen, or a similar device. In some cases, I/O controller 1345 may be implemented as part of a processor. In some cases, a user may interact with device 1305 via I/O controller 1345 or via hardware components controlled by I/O controller 1345.

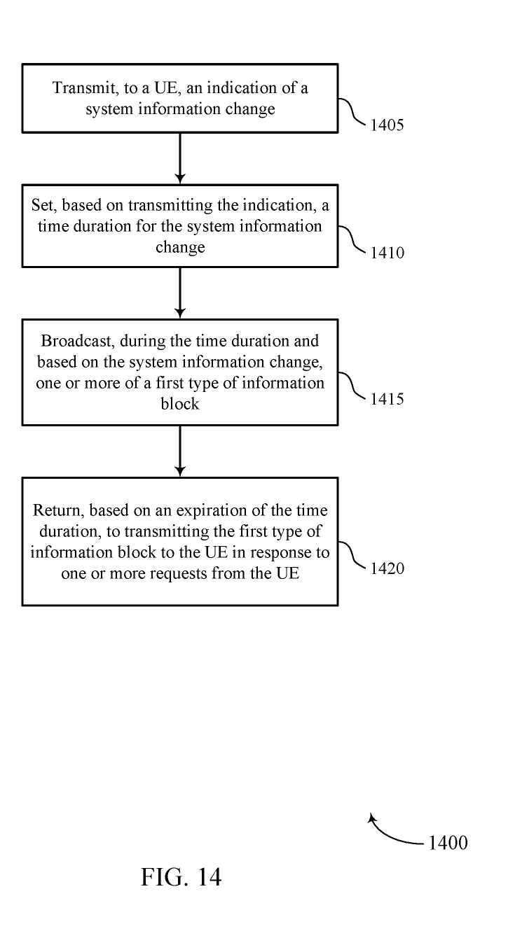

FIG. 14 shows a flowchart illustrating a method 1400 for improved system information updating for cellular systems in accordance with aspects of the present disclosure. The operations of method 1400 may be implemented by a base station 105 or its components as described herein. For example, the operations of method 1400 may be performed by a base station communications manager as described with reference to FIGS. 6 through 9. In some examples, a base station 105 may execute a set of codes to control the functional elements of the device to perform the functions described below. Additionally or alternatively, the base station 105 may perform aspects of the functions described below using special-purpose hardware.

At block 1405 the base station 105 may transmit, to a UE, an indication of a system information change. The operations of block 1405 may be performed according to the methods described herein. In certain examples, aspects of the operations of block 1405 may be performed by a system information manager as described with reference to FIGS. 6 through 9.

At block 1410 the base station 105 may set, based at least in part on transmitting the indication, a time duration for the system information change. The operations of block 1410 may be performed according to the methods described herein. In certain examples, aspects of the operations of block 1410 may be performed by a broadcast timing manager as described with reference to FIGS. 6 through 9.

At block 1415 the base station 105 may broadcast, during the time duration and based at least in part on the system information change, one or more of a first type of information block. The operations of block 1415 may be performed according to the methods described herein. In certain examples, aspects of the operations of block 1415 may be performed by a system information broadcast manager as described with reference to FIGS. 6 through 9.

At block 1420 the base station 105 may return, based at least in part on an expiration of the time duration, to transmitting the first type of information block to the UE in response to one or more requests from the UE. The operations of block 1420 may be performed according to the methods described herein. In certain examples, aspects of the operations of block 1420 may be performed by a system information manager as described with reference to FIGS. 6 through 9.

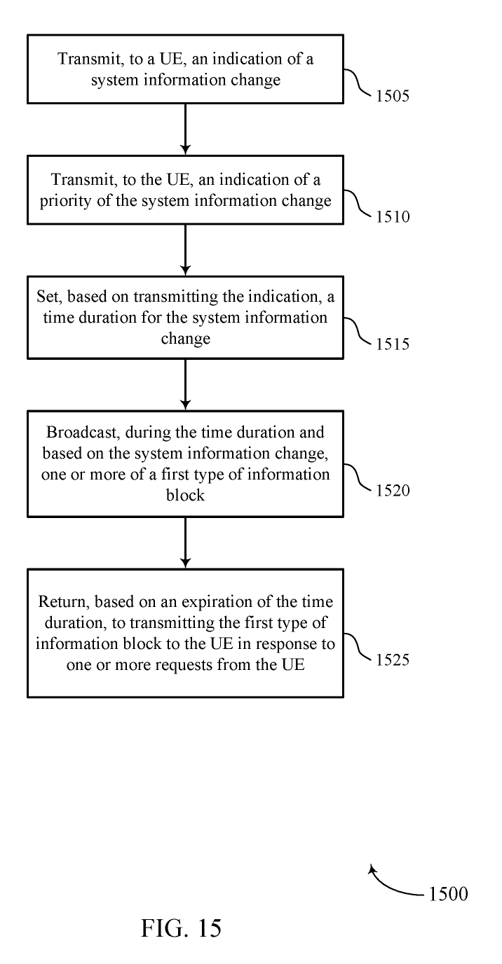

FIG. 15 shows a flowchart illustrating a method 1500 for improved system information updating for cellular systems in accordance with aspects of the present disclosure. The operations of method 1500 may be implemented by a base station 105 or its components as described herein. For example, the operations of method 1500 may be performed by a base station communications manager as described with reference to FIGS. 6 through 9. In some examples, a base station 105 may execute a set of codes to control the functional elements of the device to perform the functions described below. Additionally or alternatively, the base station 105 may perform aspects of the functions described below using special-purpose hardware.

At block 1505 the base station 105 may transmit, to the UE, an indication of a system information change. The operations of block 1505 may be performed according to the methods described herein. In certain examples, aspects of the operations of block 1505 may be performed by a system information manager as described with reference to FIGS. 6 through 9.

At block 1510 the base station 105 may transmit, to the UE, an indication of a priority of the system information change. The operations of block 1510 may be performed according to the methods described herein. In certain examples, aspects of the operations of block 1510 may be performed by a system information priority manager as described with reference to FIGS. 6 through 9.

At block 1515 the base station 105 may set, based at least in part on transmitting the indication, a time duration for the system information change. The operations of block 1515 may be performed according to the methods described herein. In certain examples, aspects of the operations of block 1515 may be performed by a broadcast timing manager as described with reference to FIGS. 6 through 9.

At block 1520 the base station 105 may broadcast, during the time duration and based at least in part on the system information change, one or more of a first type of information block. The operations of block 1520 may be performed according to the methods described herein. In certain examples, aspects of the operations of block 1520 may be performed by a system information broadcast manager as described with reference to FIGS. 6 through 9.

At block 1525 the base station 105 may return, based at least in part on an expiration of the time duration, to transmitting the first type of information block to the UE in response to one or more requests from the UE. The operations of block 1525 may be performed according to the methods described herein. In certain examples, aspects of the operations of block 1525 may be performed by a system information manager as described with reference to FIGS. 6 through 9.

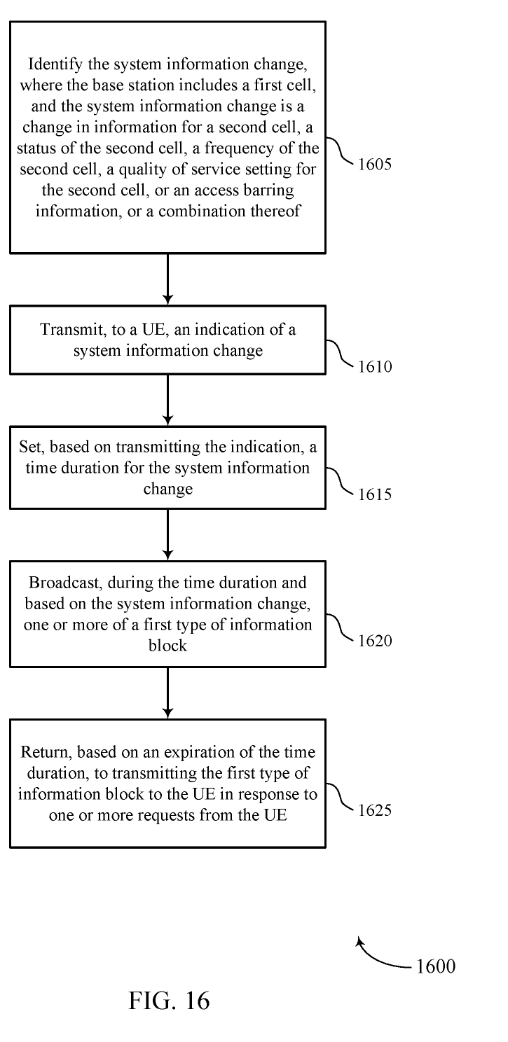

FIG. 16 shows a flowchart illustrating a method 1600 for improved system information updating for cellular systems in accordance with aspects of the present disclosure. The operations of method 1600 may be implemented by a base station 105 or its components as described herein. For example, the operations of method 1600 may be performed by a base station communications manager as described with reference to FIGS. 6 through 9. In some examples, a base station 105 may execute a set of codes to control the functional elements of the device to perform the functions described below. Additionally or alternatively, the base station 105 may perform aspects of the functions described below using special-purpose hardware.

At block 1605 the base station 105 may identify the system information change, wherein the base station includes a first cell, and the system information change is a change in information for a second cell. In some cases, the base station 105 may identify a status of the second cell, a frequency of the second cell, a quality of service setting for the second cell, or an access barring information, or a combination thereof. The operations of block 1605 may be performed according to the methods described herein. In certain examples, aspects of the operations of block 1605 may be performed by a system information update manager as described with reference to FIGS. 6 through 9.

At block 1610 the base station 105 may transmit, to a UE, an indication of a system information change. The operations of block 1610 may be performed according to the methods described herein. In certain examples, aspects of the operations of block 1610 may be performed by a system information manager as described with reference to FIGS. 6 through 9.

At block 1615 the base station 105 may set, based at least in part on transmitting the indication, a time duration for the system information change. The operations of block 1615 may be performed according to the methods described herein. In certain examples, aspects of the operations of block 1615 may be performed by a broadcast timing manager as described with reference to FIGS. 6 through 9.

At block 1620 the base station 105 may broadcast, during the time duration and based at least in part on the system information change, one or more of a first type of information block. The operations of block 1620 may be performed according to the methods described herein. In certain examples, aspects of the operations of block 1620 may be performed by a system information broadcast manager as described with reference to FIGS. 6 through 9.

At block 1625 the base station 105 may return, based at least in part on an expiration of the time duration, to transmitting the first type of information block to the UE in response to one or more requests from the UE. The operations of block 1625 may be performed according to the methods described herein. In certain examples, aspects of the operations of block 1625 may be performed by a system information manager as described with reference to FIGS. 6 through 9.

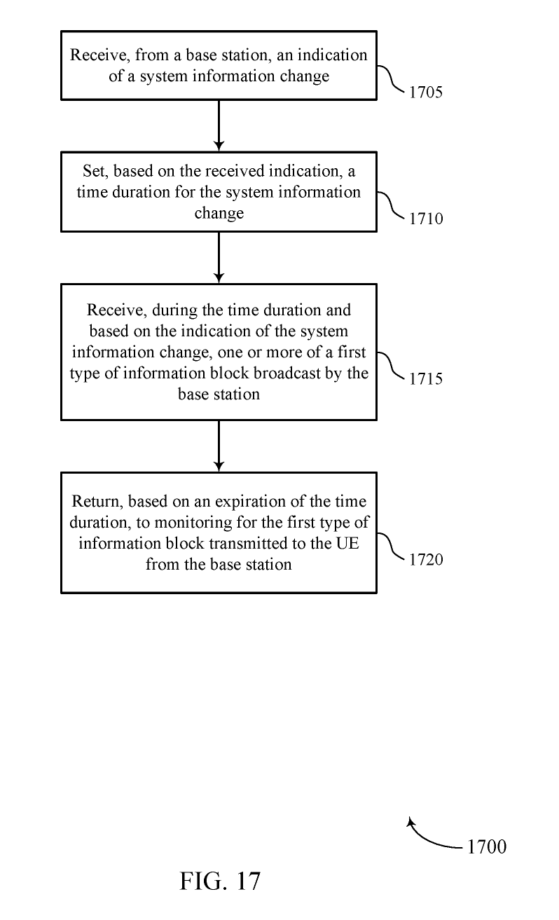

FIG. 17 shows a flowchart illustrating a method 1700 for improved system information updating for cellular systems in accordance with aspects of the present disclosure. The operations of method 1700 may be implemented by a UE 115 or its components as described herein. For example, the operations of method 1700 may be performed by a UE communications manager as described with reference to FIGS. 10 through 13. In some examples, a UE 115 may execute a set of codes to control the functional elements of the device to perform the functions described below. Additionally or alternatively, the UE 115 may perform aspects of the functions described below using special-purpose hardware.

At block 1705 the UE 115 may receive, from a base station, an indication of a system information change. The operations of block 1705 may be performed according to the methods described herein. In certain examples, aspects of the operations of block 1705 may be performed by a system information update manager as described with reference to FIGS. 10 through 13.

At block 1710 the UE 115 may set, based at least in part on the received indication, a time duration for the system information change. The operations of block 1710 may be performed according to the methods described herein. In certain examples, aspects of the operations of block 1710 may be performed by a system information time manager as described with reference to FIGS. 10 through 13.

At block 1715 the UE 115 may receive, during the time duration and based at least in part on the indication of the system information change, one or more of a first type of information block broadcast by the base station. The operations of block 1715 may be performed according to the methods described herein. In certain examples, aspects of the operations of block 1715 may be performed by a system information manager as described with reference to FIGS. 10 through 13.

At block 1720 the UE 115 may return, based at least in part on an expiration of the time duration, to monitoring for the first type of information block transmitted to the UE from the base station. The operations of block 1720 may be performed according to the methods described herein. In certain examples, aspects of the operations of block 1720 may be performed by a system information manager as described with reference to FIGS. 10 through 13.

It should be noted that the methods described above describe possible implementations, and that the operations and the steps may be rearranged or otherwise modified and that other implementations are possible. Furthermore, aspects from two or more of the methods may be combined.

Techniques described herein may be used for various wireless communications systems such as code division multiple access (CDMA), time division multiple access (TDMA), frequency division multiple access (FDMA), orthogonal frequency division multiple access (OFDMA), single carrier frequency division multiple access (SC-FDMA), and other systems. The terms “system” and “network” are often used interchangeably. A CDMA system may implement a radio technology such as CDMA2000, Universal Terrestrial Radio Access (UTRA), etc. CDMA2000 covers IS-2000, IS-95, and IS-856 standards. IS-2000 Releases may be commonly referred to as CDMA2000 1×, 1×, etc. IS-856 (TIA-856) is commonly referred to as CDMA2000 1×EV-DO, High Rate Packet Data (HRPD), etc. UTRA includes Wideband CDMA (WCDMA) and other variants of CDMA. A TDMA system may implement a radio technology such as Global System for Mobile Communications (GSM).

An OFDMA system may implement a radio technology such as Ultra Mobile Broadband (UMB), Evolved UTRA (E-UTRA), Institute of Electrical and Electronics Engineers (IEEE) 802.11 (Wi-Fi), IEEE 802.16 (WiMAX), IEEE 802.20, Flash-OFDM, etc. UTRA and E-UTRA are part of Universal Mobile Telecommunications System (UMTS). LTE and LTE-A are releases of UMTS that use E-UTRA. UTRA, E-UTRA, UMTS, LTE, LTE-A, NR, and GSM are described in documents from the organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies. While aspects of an LTE or an NR system may be described for purposes of example, and LTE or NR terminology may be used in much of the description, the techniques described herein are applicable beyond LTE or NR applications.

In LTE/LTE-A networks, including such networks described herein, the term evolved node B (eNB) may be generally used to describe the base stations. The wireless communications system or systems described herein may include a heterogeneous LTE/LTE-A or NR network in which different types of eNBs provide coverage for various geographical regions. For example, each eNB, next generation NodeB (gNB), or base station may provide communication coverage for a macro cell, a small cell, or other types of cell. The term “cell” may be used to describe a base station, a carrier or component carrier associated with a base station, or a coverage area (e.g., sector, etc.) of a carrier or base station, depending on context.

Base stations may include or may be referred to by those skilled in the art as a base transceiver station, a radio base station, an access point, a radio transceiver, a NodeB, eNodeB (eNB), gNB, Home NodeB, a Home eNodeB, or some other suitable terminology. The geographic coverage area for a base station may be divided into sectors making up only a portion of the coverage area. The wireless communications system or systems described herein may include base stations of different types (e.g., macro or small cell base stations). The UEs described herein may be able to communicate with various types of base stations and network equipment including macro eNBs, small cell eNBs, gNBs, relay base stations, and the like. There may be overlapping geographic coverage areas for different technologies.

A macro cell generally covers a relatively large geographic area (e.g., several kilometers in radius) and may allow unrestricted access by UEs with service subscriptions with the network provider. A small cell is a lower-powered base station, as compared with a macro cell, that may operate in the same or different (e.g., licensed, unlicensed, etc.) frequency bands as macro cells. Small cells may include pico cells, femto cells, and micro cells according to various examples. A pico cell, for example, may cover a small geographic area and may allow unrestricted access by UEs with service subscriptions with the network provider. A femto cell may also cover a small geographic area (e.g., a home) and may provide restricted access by UEs having an association with the femto cell (e.g., UEs in a closed subscriber group (CSG), UEs for users in the home, and the like). An eNB for a macro cell may be referred to as a macro eNB. An eNB for a small cell may be referred to as a small cell eNB, a pico eNB, a femto eNB, or a home eNB. An eNB may support one or multiple (e.g., two, three, four, and the like) cells (e.g., component carriers).

The wireless communications system or systems described herein may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. The techniques described herein may be used for either synchronous or asynchronous operations.

The downlink transmissions described herein may also be called forward link transmissions while the uplink transmissions may also be called reverse link transmissions. Each communication link described herein—including, for example, wireless communications system 100 and 200 of FIGS. 1 and 2—may include one or more carriers, where each carrier may be a signal made up of multiple sub-carriers (e.g., waveform signals of different frequencies).

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media may comprise RAM, ROM, electrically erasable programmable read only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for wireless communication at a base station, comprising:
transmitting, to a user equipment (UE), an indication of a system information change;
setting, based at least in part on transmitting the indication, a time duration for the system information change;
broadcasting, during the time duration and based at least in part on the system information change, one or more of a first type of information block; and
returning, based at least in part on an expiration of the time duration, to transmitting the first type of information block to the UE in response to one or more requests from the UE.

2. The method of claim 1, further comprising:
transmitting, to the UE, an indication of a priority of the system information change.

3. The method of claim 1, wherein transmitting the indication of the system information change comprises:
transmitting a paging message, the paging message including a cause field indicating the system information change, or an information block type, or a combination thereof.

4. The method of claim 1, further comprising:
receiving a plurality of requests to transmit the first type of information block from a plurality of UEs served by the base station; and
identifying that a number of the plurality of requests satisfy a threshold, wherein the indication of the system information change is transmitted based at least in part on the identification.

5. The method of claim 1, wherein broadcasting the one or more of the first type of information block comprises:
broadcasting a first of the first type of information block together with at least one other of the first type of information block.

6. The method of claim 1, wherein broadcasting the one or more of the first type of information block comprises:
broadcasting a first of the first type of information block together with a second type of information block.

7. The method of claim 6, wherein the first type of information block is associated with a first repetition rate and the second type of information block is associated with a second repetition rate.

8. The method of claim 6, wherein:
the first type of information block is an other system information block (ORB); and
the second type of information block is a minimum system information block (MSIB).

9. The method of claim 1, wherein broadcasting the one or more of the first type of information block comprises:
broadcasting a plurality of instances of the one or more of the first type of information block during the time duration.

10. The method of claim 1, further comprising:
broadcasting a second type of information block, wherein the second type of information block comprises information for at least one of the one or more of the first type of information block.

11. The method of claim 10, wherein the information for at least one of the one or more of the first type of information block comprises an indicator to identify the one or more of the first type of information block as periodic or as provided on request, a type, or a validity, or a periodicity, or a window, or a combination thereof.

12. The method of claim 1, further comprising:
identifying the system information change, wherein the base station includes a first cell, and the system information change is a change in information for a second cell.

13. The method of claim 12, further comprising:
identifying a status of the second cell, or a frequency of the second cell, or a quality of service setting for the second cell, or an access barring information, or a combination thereof.

14. A method for wireless communication at a user equipment (UE), comprising:
receiving, from a base station, an indication of a system information change;
setting, based at least in part on the received indication, a time duration for the system information change;
receiving, during the time duration and based at least in part on the indication of the system information change, one or more of a first type of information block broadcast by the base station; and
returning, based at least in part on an expiration of the time duration, to monitoring for the first type of information block transmitted to the UE from the base station.

15. The method of claim 14, further comprising:
transmitting a request for the first type of information block, wherein the one or more of the first type of information block broadcast by the base station is received based at least in part on the request.

16. The method of claim 14, wherein receiving the one or more of the first type of information block comprises:
receiving, from the base station, a first of the first type of information block together with at least one other of the first type of information block.

17. The method of claim 14, wherein receiving the one or more of the first type of information block comprises:
receiving, from the base station, a first of the first type of information block together with a second type of information block.

18. The method of claim 14, further comprising:
receiving a second type of information block, wherein the second type of information block comprises information for at least one of the one or more of the first type of information block.

19. The method of claim 18, wherein the first type of information block is associated with a first repetition rate and the second type of information block is associated with a second repetition rate.

20. The method of claim 18, wherein the information for at least one of the one or more of the first type of information block comprises an indicator to identify the one or more of the first type of information block as periodic or as provided on request, a type, or a validity, or a periodicity, or a window, or a combination thereof.

21. The method of claim 18, wherein:
the first type of information block is an other system information block (ORB); and
the second type of information block is a minimum system information block (MSIB).

22. An apparatus for wireless communication at a base station, comprising:
means for transmitting, to a user equipment (UE), an indication of a system information change;
means for setting, based at least in part on transmitting the indication, a time duration for the system information change;
means for broadcasting, during the time duration and based at least in part on the system information change, one or more of a first type of information block; and
means for returning, based at least in part on an expiration of the time duration, to transmitting the first type of information block to the UE in response to one or more requests from the UE.

23. The apparatus of claim 22, further comprising:
means for transmitting, to the UE, an indication of a priority of the system information change.

24. The apparatus of claim 22, wherein the means for transmitting the indication of the system information change comprises:
means for transmitting a paging message, the paging message including a cause field indicating the system information change, or an information block type, or a combination thereof.

25. The apparatus of claim 22, further comprising:
means for receiving a plurality of requests to transmit the first type of information block from a plurality of UEs served by the base station; and
means for identifying that a number of the plurality of requests satisfy a threshold, wherein the indication of the system information change is transmitted based at least in part on the identification.

26. The apparatus of claim 22, wherein the means for broadcasting the one or more of the first type of information block comprises:
means for broadcasting a first of the first type of information block together with at least one other of the first type of information block.

27. The apparatus of claim 22, wherein the means for broadcasting the one or more of the first type of information block comprises:
means for broadcasting a first of the first type of information block together with a second type of information block.

28. The apparatus of claim 27, wherein the first type of information block is associated with a first repetition rate and the second type of information block is associated with a second repetition rate.

29. The apparatus of claim 27, wherein:
the first type of information block is an other system information block (ORB); and
the second type of information block is a minimum system information block (MSIB).

30. The apparatus of claim 22, wherein broadcasting the one or more of the first type of information block comprises:
means for broadcasting a plurality of instances of the one or more of the first type of information block during the time duration.

31. The apparatus of claim 22, further comprising:
means for broadcasting a second type of information block, wherein the second type of information block comprises information for at least one of the one or more of the first type of information block.

32. The apparatus of claim 31, wherein:
the information for at least one of the one or more of the first type of information block comprises an indicator to identify the one or more of the first type of information block as periodic or as provided on request, a type, or a validity, or a periodicity, or a window, or a combination thereof.

33. The apparatus of claim 22, further comprising:
means for identifying the system information change, wherein the base station includes a first cell, and the system information change is a change in information for a second cell

34. The apparatus of claim 22, further comprising:
means for identifying a status of the second cell, a frequency of the second cell, a quality of service setting for the second cell, or an access barring information, or a combination thereof.

35. An apparatus for wireless communication at a user equipment (UE), comprising:
means for receiving, from a base station, an indication of a system information change;
means for setting, based at least in part on the received indication, a time duration for the system information change;
means for receiving, during the time duration and based at least in part on the indication of the system information change, one or more of a first type of information block broadcast by the base station; and
means for returning, based at least in part on an expiration of the time duration, to monitoring for the first type of information block transmitted to the UE from the base station.

36. The apparatus of claim 35, further comprising:
means for transmitting a request for the first type of information block, wherein the one or more of the first type of information block broadcast by the base station is received based at least in part on the request.

37. The apparatus of claim 35, wherein the means for receiving the one or more of the first type of information block comprises:
means for receiving, from the base station, a first of the first type of information block together with at least one other of the first type of information block.

38. The apparatus of claim 35, wherein the means for receiving the one or more of the first type of information block comprises:
means for receiving, from the base station, a first of the first type of information block together with a second type of information block.

39. The apparatus of claim 35, further comprising:
means for receiving a second type of information block, wherein the second type of information block comprises information for at least one of the one or more of the first type of information block.

40. The apparatus of claim 39, wherein the first type of information block is associated with a first repetition rate and the second type of information block is associated with a second repetition rate.

41. The apparatus of claim 39, wherein:
the information for at least one of the one or more of the first type of information block comprises an indicator to identify the one or more of the first type of information block as periodic or as provided on request, a type, or a validity, or a periodicity, or a window, or a combination thereof.

42. The apparatus of claim 39, wherein:
the first type of information block is an other system information block (ORB); and
the second type of information block is a minimum system information block (MSIB).

43. An apparatus for wireless communication at a base station, comprising:
a processor;
memory in electronic communication with the processor; and
instructions stored in the memory and operable, when executed by the processor, to cause the apparatus to:
transmit, to a user equipment (UE), an indication of a system information change;
set, based at least in part on transmitting the indication, a time duration for the system information change;
broadcast, during the time duration and based at least in part on the system information change, one or more of a first type of information block; and
return, based at least in part on an expiration of the time duration, to transmitting the first type of information block to the UE in response to one or more requests from the UE.

44. The apparatus of claim 43, wherein the instructions are further executable by the processor to:
transmit, to the UE, an indication of a priority of the system information change.

45. The apparatus of claim 43, wherein the instructions executable by the processor to transmit the indication of the system information change comprises instructions further executable by the processor to:
transmit a paging message, the paging message including a cause field indicating the system information change, or an information block type, or a combination thereof.

46. The apparatus of claim 43, wherein the instructions are further executable by the processor to:
receive a plurality of requests to transmit the first type of information block from a plurality of UEs served by the base station; and
identify that a number of the plurality of requests satisfy a threshold, wherein the indication of the system information change is transmitted based at least in part on the identification.

47. The apparatus of claim 43, wherein the instructions executable by the processor to broadcast the one or more of the first type of information block comprises instructions further executable by the processor to:
broadcast a first of the first type of information block together with at least one other of the first type of information block.

48. The apparatus of claim 43, wherein the instructions executable by the processor to broadcast the one or more of the first type of information block comprises instructions further executable by the processor to:
broadcast a first of the first type of information block together with a second type of information block.

49. The apparatus of claim 48, wherein the first type of information block is associated with a first repetition rate and the second type of information block is associated with a second repetition rate.

50. The apparatus of claim 48, wherein:
the first type of information block is an other system information block (ORB); and
the second type of information block is a minimum system information block (MSIB).

51. The apparatus of claim 43, wherein the instructions executable by the processor to broadcast the one or more of the first type of information block comprises instructions further executable by the processor to:
broadcast a plurality of instances of the one or more of the first type of information block during the time duration.

52. The apparatus of claim 43, wherein the instructions are further executable by the processor to:
broadcast a second type of information block, wherein the second type of information block comprises information for at least one of the one or more of the first type of information block.

53. The apparatus of claim 52, wherein the information for at least one of the one or more of the first type of information block comprises an indicator to identify the one or more of the first type of information block as periodic or as provided on request, a type, or a validity, or a periodicity, or a window, or a combination thereof.

54. The apparatus of claim 43, wherein the instructions are further executable by the processor to:
identify the system information change, wherein the base station includes a first cell, and the system information change is a change in information for a second cell,

55. The apparatus of claim 43, wherein the instructions are further executable by the processor to:
identify a status of the second cell, or a frequency of the second cell, or a quality of service setting for the second cell, or an access barring information, or a combination thereof.

56. An apparatus for wireless communication at a user equipment (UE), comprising:
a processor;
memory in electronic communication with the processor; and
instructions stored in the memory and operable, when executed by the processor, to cause the apparatus to:
receive, from a base station, an indication of a system information change;
set, based at least in part on the received indication, a time duration for the system information change;
receive, during the time duration and based at least in part on the indication of the system information change, one or more of a first type of information block broadcast by the base station; and
return, based at least in part on an expiration of the time duration, to monitoring for the first type of information block transmitted to the UE from the base station.

57. The apparatus of claim 56, wherein the instructions are further executable by the processor to:
transmit a request for the first type of information block, wherein the one or more of the first type of information block broadcast by the base station is received based at least in part on the request.

58. The apparatus of claim 56, wherein the instructions executable by the processor to receive the one or more of the first type of information block comprise instructions further executable by the processor to:
receive, from the base station, a first of the first type of information block together with at least one other of the first type of information block.

59. The apparatus of claim 56, wherein the instructions executable by the processor to receive the one or more of the first type of information block comprises instructions further executable by the processor to:
receive, from the base station, a first of the first type of information block together with a second type of information block.

60. The apparatus of claim 56, wherein the instructions are further executable by the processor to:
receive a second type of information block, wherein the second type of information block comprises information for at least one of the one or more of the first type of information block.

61. The apparatus of claim 60, wherein the first type of information block is associated with a first repetition rate and the second type of information block is associated with a second repetition rat

62. The apparatus of claim 60, wherein the information for at least one of the one or more of the first type of information block comprises an indicator to identify the one or more of the first type of information block as periodic or as provided on request, a type, or a validity, or a periodicity, or a window, or a combination thereof.

63. The apparatus of claim 60, wherein:
the first type of information block is an other system information block (ORB); and
the second type of information block is a minimum system information block (MSIB).

64. A non-transitory computer readable medium storing code for wireless communication, the code comprising instructions executable by a processor to:
transmit, to a user equipment (UE), an indication of a system information change;
set, based at least in part on transmitting the indication, a time duration for the system information change;
broadcast, during the time duration and based at least in part on the system information change, one or more of a first type of information block; and
return, based at least in part on an expiration of the time duration, to transmitting the first type of information block to the UE in response to one or more requests from the UE.

65. A non-transitory computer readable medium storing code for wireless communication, the code comprising instructions executable by a processor to:
receive, from a base station, an indication of a system information change;
set, based at least in part on the received indication, a time duration for the system information change;
receive, during the time duration and based at least in part on the indication of the system information change, one or more of a first type of information block broadcast by the base station; and
return, based at least in part on an expiration of the time duration, to monitoring for the first type of information block transmitted to the UE from the base station.
